(19) United States
(12) Patent Application Publication
(10) Pub. No.: US 2014/0195094 A1
(43) Pub. Date: Jul. 10, 2014

(54) Microcrawler and Conveyor Robots, Controllers, Systems, and Methods

(71) Applicant: The Board of Regents of the University of Texas System, (US)

(72) Inventors: Dan O. Popa, Roanoke, TX (US); Rakesh Murthy, Arlington, TX (US); Aditya N. Das, Arlington, TX (US)

(73) Assignee: The Board of Regents of the University of Texas System, Austin, TX (US)

(21) Appl. No.: 13/866,513

(22) Filed: Apr. 19, 2013

Related U.S. Application Data
(63) Continuation of application No. 12/583,331, filed on Aug. 18, 2009, now abandoned.
(60) Provisional application No. 61/089,599, filed on Aug. 18, 2008.

(51) Int. Cl. B62D 57/02; B25J 9/16

(52) U.S. Cl. CPC B62D 57/02; B25J 9/1697
USPC 701/25; 180/8.1; 901/1

(57) ABSTRACT

Robots, controllers, systems, and methods for microcrawler robots (e.g., with stick-slip gaited locomotion and/or with power multiplexing between actuators).

### CROSS-REFERENCE TO RELATED APPLICATIONS

This application is a continuation of U.S. patent application Ser. No. 12/583,331, filed Aug. 18, 2009, which claims priority to U.S. Provisional Application No. 61/089,599, filed Aug. 18, 2008, both of which are incorporated by reference in their entireties.

### GOVERNMENT SUPPORT

This invention was made with government support under research grants #N00014-06-1-1150 and #N00014-05-1-0587 awarded by the Office of Naval Research. The government has certain rights in the invention.

### BACKGROUND OF THE INVENTION

1. Field of the Invention

The present invention relates generally to robots, and, more particularly, but not by way of limitation, to microrobots that are configured to crawl and/or function as conveyors, and to methods, devices, and systems for sequentially actuating robot locomotion elements to conserve power and/or extend battery life.

2. Description of Related Art

Microrobotics has been an active research area for almost two decades, and may have applications in various fields, such as, for example, in surgery and drug delivery, surveillance applications (e.g., camera- and/or microphone-carrying robots), microfactory applications (e.g., micropositioning and/or assembly). Microrobots generally have overall volumes between a few cubic millimeters (mm³) and a few cubic centimeters (cm³) and/or comprise precision-machined microactuators and other components. Microsystems and nano technology are some driving forces toward sustaining miniaturization and further miniaturizing such microrobots. Using fabrication techniques such as PolyMUMPS® and Deep Reactive Ion Etching (DRIE), several teams have proposed microcrawling robots.

A variety of autonomous or semi-autonomous mobile microrobots have been developed over the years for surveillance and combat applications, exhibiting various forms of locomotion such as those traditionally referred to as rolling, walking, climbing, crawling, jumping and flying. Among these forms of locomotion, walking and crawling have been employed on mobile robots of various sizes [1]. Micro autonomous vehicles (MAVs) have recently drawn attention recently for various urban and military applications. As such, some research activities in this field have focused on applications such as reconnaissance and surveillance, search and rescue, detection of biological and chemical materials, and the like [2]. Multi-legged, cilia-like locomotion has also been demonstrated using Micro-Electro-Mechanical-Systems (MEMS). Examples include a 15 mm×5 mm×1.5 mm microrobot with polyimide joints that could reportedly reach a velocity of 6 mm/s [3]; a 10 mm×10 mm×0.5 mm, 90+ legged crawler, though it exhibited payload carrying limitations [4]; and a 30 mm×10 mm×1 mm, 256-legged walking robot using out-of-plane thermal actuators, and demonstrated velocities of 1 mm/s [5].

An out-of plane walking gait with 8 cilia has been proposed using Ionic polymer metal composite legs [6]. The robot dimensions were relatively large, 6 mm×3 mm×1.5 mm, and exhibited a large payload carrying capacity, but a relatively slow velocity of 0.25 mm/s. A thermal actuator based six legged microrobot is presented in [7]. This tethered microrobot could reportedly crawl at 0.1 mm/s speed, carrying a payload of approximately 3.5 g. Recent work at Ecole Polytechnique Fédérale de Lausanne (EPFL) [8] demonstrated a 1 cm×1 cm electrostatic comb-drive locomotor with 0.2 mm/s velocities, 1 cm×1 cm size, 0.2 mm/s and 16 microwatts (μW) power consumption.

Mobility using legged robots from the vantage point of the robot may be similar to manipulation of the ground. As a result, research in micro-conveyors or “active surface” manipulators may be related to micro-walkers. Arrays of many manipulators with limited force capabilities have been proposed in past research, using pneumatics, electromagnetics, piezoelectric, electrostatic and electrothermal actuation principles [9-14]. However, mobility generally requires much stricter payload, energy, force, and size constraints than manipulation, and therefore many, if not most, conveyor concepts are not feasible as mobile untethered crawlers. Another category of microrobots are powered under ambient electric or magnetic fields and have been prototyped for microscale self-configuration applications. These microrobots are typically fabricated with lateral dimensions below 250 μm [15].

### SUMMARY OF THE INVENTION

The present disclosure includes various embodiments of microcrawler and conveyor robots (e.g., microrobots), controllers, systems, and methods. The present microrobots can be configured for a variety of applications. For example, scanning electron microscopy, optical microscopy, microfactory functions such as microassembly and the like, surveillance, and/or any other suitable applications. Additional applications will also likely arise due to growth of associated microsystems technologies. For example, microsensors, tools, and the like often need to be carried or manipulated. By way of another example, mobile microrobots can be used for medical and military applications. Additionally, articulated fixed-location robots can be used for microfactory applications and embodiments of the present microbots can be used to deliver and/or install such fixed-location robots in and/or on a work platform or environment.

Recent advances in microfabrication and hybrid microassembly (e.g., MEMS snap fasteners, die-level bonding for interconnects, etc.) can expedite the rapid prototyping of new Micro Autonomous Vehicles (MAVs), such as the present microrobots, that may be configured for various functions (e.g., flying, crawling, jumping, etc.). The present microrobots can be configured to be: large enough to carry any suitable micro manipulation/sensory payload; small enough to fit or be able to fit within or on multiple entities within a typical microfactory volume (e.g., an SEM chamber); and/or accurate enough (e.g., nanometer(s)) over a long range of motion (e.g., up to 0.5 m).

The present configurations of microrobots may be referred to in this disclosure as “ARRIpede.” In some embodiments, the ARRIpede configuration is an example of a “die-size” crawling microrobot that can be constructed by assembly and/or die stacking Some embodiments comprise: a MEMS die “body,” in-plane (e.g., parallel to a surface that supports it), and its configuration or anatomy can comprise: silicon electrothermal prismatic actuators, vertical and/or vertically assembled legs coupled to the actuators via sockets in complaint joints, and an electronics “backpack” or module that carries one or more electronic components (e.g., voltage amplifier, voltage regulator, current regulator, controller, etc.) configured to generate and/or regulate power for the actuators, and/or control a gait sequence, and/or enable the microrobot to operate autonomously.

In one prototyped embodiment, a 6-legged microrobot of approximate dimension of 15 mm×15 mm×5 mm, including an electronics backpack, was constructed and tested. This microrobot was designed to carry higher payloads and perform faster locomotion than its counterparts in [3-8]. The measured crawling speeds were up to 1.55 mm/s for a body mass of 3.8 g, and the a nominal load carrying capacity was 9 g, more than twice its own weight. Power was cycled between individual robot legs to obtain a gait motion, and overall power consumption was thus equivalent to that of a single continuously powered chevron electrothermal actuator (e.g., hundreds of mW). By slowing the robot by a factor of ten, power consumption can likely be reduced by a factor of 100, likely making autonomy feasible with ordinary batteries.

Some embodiments of the present robots comprise: a body; a plurality of actuators coupled to the body, the plurality of actuators each actuatable in a single degree-of-freedom (DOF); and a plurality of legs each coupled to a different actuator and extending from that actuator at a nonparallel angle relative to the DOF of that actuator; where the robot is configured such that if the robot is disposed with the legs extending upward from the body and a payload is supported by the legs above the body, the actuators can move the legs in a sequence to move the payload laterally.

In some embodiments, the robot is configured such that if the robot is disposed on a suitable surface with the legs supporting the body above the surface, the actuators can move the legs in a sequence to move the robot across the surface. In some embodiments, each leg is substantially perpendicular to the DOF of the actuator to which the leg is coupled. In some embodiments, the DOF of each actuator is linear along an axis, and where the axis of at least one actuator is substantially parallel to the axis of at least one other actuator. In some embodiments, the axes of all the actuators are substantially parallel to each other.

In some embodiments, the body comprises a microelectromechanical-systems (MEMS) die having a plurality of prismatic joints, each joint including one of the actuators and a socket coupled to that actuator and configured to be coupled to a leg, and where the DOF of each actuator is in substantially the same plane as the DOF of each of the other actuators. In some embodiments, each leg is substantially perpendicular to the DOF of the actuator to which the leg is coupled. In some embodiments, the legs comprise Silicon. In some embodiments, the robot is a microrobot. In some embodiments, each actuator is a chevron electro-thermal actuator and each leg is coupled to a socket with a microsnap fastener. In some embodiments, each leg is coupled to a socket with ultraviolet (UV)-epoxy.

In some embodiments, the robot further comprises: a plurality of boots each coupled to a different one of the legs. In some embodiments, the robot further comprises: an electronics module coupled to the actuators and configured to actuate the actuators to sequentially move the legs relative to the body. In some embodiments, the electronics module is configured such that if the actuators are actuated to sequentially move the legs at a rate, current is time-multiplexed to the actuators at a faster rate than the rate of the sequential movement of the legs. In some embodiments, the electronics module comprises a power module and a controller.

Some embodiments of the present controllers comprise: a microcontroller configured such that if coupled to a power source and a plurality of actuators, the microcontroller can be activated to sequentially actuate the actuators at a rate by time-multiplexing current to the actuators at a faster rate than the rate of sequential actuation of the actuators.

In some embodiments, the microcontroller is configured such that if the rate of sequential actuation of the actuators is reduced by a factor of ten, the rate of power consumption of the actuators is reduced by a factor of about one hundred. In some embodiments, the microcontroller is configured such that if the microcontroller is activated to sequentially actuate the actuators, the microcontroller can sequentially actuate the actuators to consume 100 to 400 milliamps (mA) of current at a voltage of eighteen to twenty volts across the actuators.

Some embodiments of the present microrobots comprise: a plurality of actuators; and a microcontroller coupled to the actuators and configured such that if coupled to a power source, the controller can be activated to sequentially actuate the actuators at a rate by time-multiplexing current to the actuators at a faster rate than the rate of sequential actuation of the actuators. In some embodiments, the microcontroller is configured such that if the rate of sequential actuation of the actuators is reduced by a factor of ten, the rate of power consumption of the actuators is reduced by a factor of about one hundred. In some embodiments, the microcontroller is configured such that if the microcontroller is activated to sequentially actuate the actuators, the microcontroller can sequentially actuate the actuators to consume 100 to 400 milliamps (mA) of current at a voltage of eighteen to twenty volts across the actuators. In some embodiments, the microcontroller is configured to sequentially actuate one or more actuators at a first frequency and one or more other actuators at a second frequency to steer the microrobot according to a fifth-order vector model.

Some embodiments of the present systems comprise: a computer having a trajectory planner configured to generate instructions for a robot to travel along a planned trajectory, (the robot comprising: a body; a plurality of actuators coupled to the body, the plurality of actuators each actuatable in a single degree-of-freedom (DOF); and a plurality of legs each coupled to a different actuator and extending from that actuator at a nonparallel angle relative to the DOF of that actuator; where the robot is configured such that if the robot is disposed with the legs extending upward from the body and a payload is supported by the legs above the body, the actuators can move the legs in a sequence to move the payload laterally); and an image sensor coupled to the computer and configured to provide image data having a resolution to the computer; where the computer is configured to generate instructions for the robot to follow the planned trajectory based upon a position of the robot determined from the image data. In some embodiments, the system further comprises: a fine-position sensor coupled to the computer and configured to provide fine-position data having a resolution greater than the resolution of the image data; where the computer is configured to generate instructions for the robot to follow the planned trajectory based upon the position of the robot determined from the image data and from the fine-position data.

Any embodiment of any of the present methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. In the figures that depict photographs of a given structure, such structures are shown to scale.

FIGS. 1A-1D depict various parts and features of one of the present microrobots.

FIG. 2 conceptually illustrates one of the present gait sequences for one of the present six-legged robots.

FIGS. 3A-3B depict displacement vs. voltage and current vs. voltage for one of the present electrothermal actuators used in embodiments of the present robots.

FIG. 4 depicts an example of a joint comprising an electrothermal actuator coupled to a legs, suitable for use in embodiments of the present robots.

FIG. 5 depicts displacement vs. time for various coefficients of friction for a leg of one of the present robots.

FIGS. 6A-6D depict various parts and features of one of the present microrobots.

FIG. 7A-7C depict a tethered prototype of one of the present robots and a payload used to test the prototype.

FIG. 8 depicts a bottom view of one of the present robots.

FIGS. 9A and 9B depict longitudinal and lateral motion, respectively, of the payload of FIGS. 7B and 7C for various combinations of actuation conditions of the legs of the prototype of FIG. 7A.

FIG. 10 depicts translation of the payload of FIGS. 7B and 7C for various actuation conditions of the legs of the prototype of FIG. 7C.

FIGS. 11A and 11B depict a method of testing the strength of the joint and leg of FIG. 4.

FIG. 12 depicts variance in leg angle relative to the body of a robot.

FIG. 13 depicts a side perspective view of one of the present robots.

FIG. 14 depicts a side view of one of the present robots.

FIG. 15 depicts a bottom perspective view of one of the present robots.

FIGS. 16A-16D depict components of an electronics backpack or module suitable for use with embodiments of the present robots.

FIGS. 17A and 17B depict characteristics of a transistor portion of a current regulator suitable for use in embodiments of the present robots.

FIG. 18 depicts a flowchart of one of the present methods for constructing embodiments of the present robot.

FIG. 19 depicts one on of the present methods for securing wires for electrical connections in embodiments of the present robots.

FIGS. 20A-20D depict schematics of components of an electronics backpack or module suitable for use with embodiments of the present robots.

FIGS. 21A, 21B, 22A, and 22B depict an alternative configuration for components of an electronics backpack suitable for use with embodiments of the present robots.

FIG. 23 depicts certain characteristics of a dynamic model for predicting motion of embodiments of the present robots.

FIG. 24 depicts certain characteristics of a dynamic model for predicting motion of embodiments of the present robots.

FIG. 25 depicts the pulses for actuating one of the present wave gaits for a six-legged embodiment of the present robots.

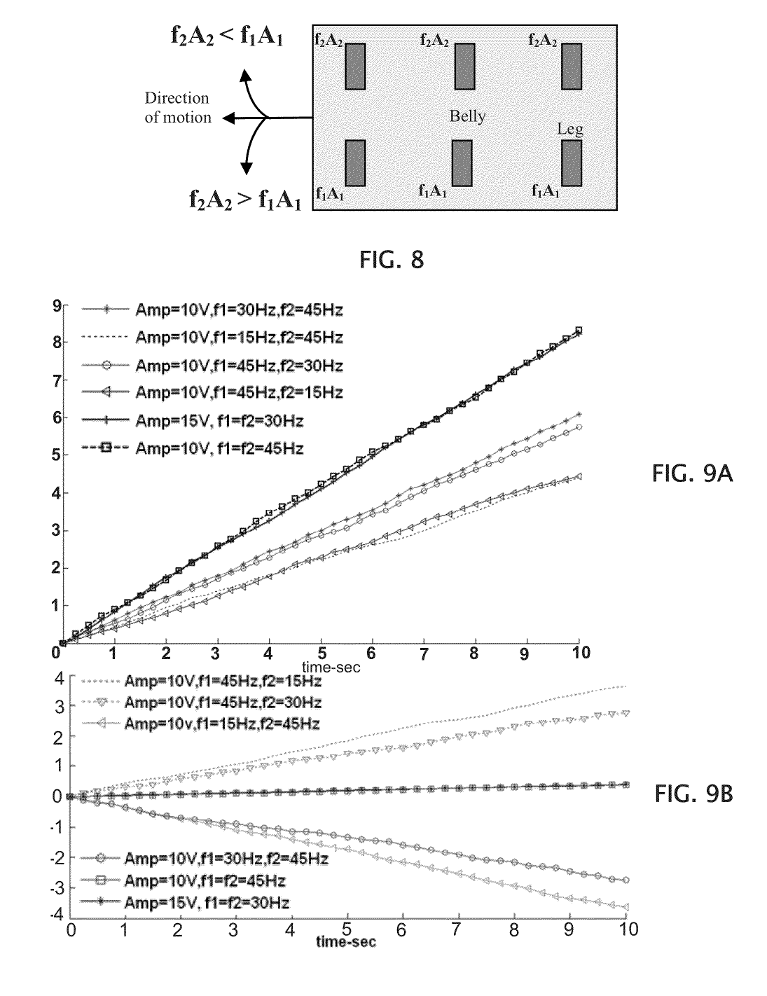

FIG. 8 depicts motion paths of one of the present robots.

FIG. 27 depicts a PWM signal-generation scheme by one of the present microcontrollers.

FIG. 28 depicts a control system suitable for use with embodiments of the present robots.

FIG. 29 depicts a control architecture suitable for use with embodiments of the present robots.

FIG. 30 depicts open- and closed-loop (LQR controller) based trajectories of one of the present robots.

### DESCRIPTION OF ILLUSTRATIVE EMBODIMENTS

The term “coupled” is defined as connected, although not necessarily directly, and not necessarily mechanically; two items that are “coupled” may be integral with each other. The terms “a” and “an” are defined as one or more unless this disclosure explicitly requires otherwise. The terms “substantially,” “approximately,” and “about” are defined as largely but not necessarily wholly what is specified, as understood by a person of ordinary skill in the art.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a robot that “comprises,” “has,” “includes” or “contains” one or more elements possesses those one or more elements, but is not limited to possessing only those elements. For example, a robot that comprises a body and a plurality of legs, can also include a plurality of boots coupled to the legs. Likewise, a system that “comprises,” “has,” “includes” or “contains” one or more elements possesses those one or more elements, but is not limited to possessing only those one or more elements. For example, a system that comprises a computer and a coarse-position sensor, can also include a fine-position sensor. Further, a method that “comprises,” “has,” “includes” or “contains” one or more steps possesses those one or more steps, but is not limited to possessing only those one or more steps. For example, a method including a step of assembling legs and a body, can also include a step of assembling the body to an electronics module.

Further, a device or structure that is configured in a certain way is configured in at least that way, but it can also be configured in other ways than those specifically described.

The versions of the present microrobots that were prototyped were designed using a stick-slip simulation model for a target volume of 1.5 cm×1.5 cm×0.5 cm, a target mass of 3.8 grams (g), and a target crawling velocity of up to 3 mm/s. The leg-actuation force, the payload carrying capacity, the power consumption, and the manipulation ability of an inverted ARRIpede prototype have been experimentally evaluated. The first prototype described in this disclosure was initially configured without an electronics “backpack” (e.g., such that it was not autonomous) as an inverted conveyer (e.g., placed on its back with its legs extending upward from the body, as described in more detail below) and payload conveyance implementing the stick-slip based actuation technique was demonstrated. Also evaluated were: the joint actuation force, the payload carrying capacity, and the power consumption. A configuration that could carry a payload approximately equal to its own weight also showed adequate steering ability. A reasonable match between simulations and experiments was noted, for example, when the legs are actuated at 45 Hz and 10 V; under such conditions, the crawling velocity of the microrobot was experimentally measured to be 0.84 mm/s or 18.7 μm per step, while the simulated leg displacement was 18.5 μm per step. The prototyped “conveyor” mode had a maximum measured linear velocity in excess of 1.5 mm/s, while consuming approximately 500 mW of power. It is expected that for achieving lower speeds, such as 0.15 mm/s, the power consumption can be reduced to a few mW (e.g., 5 mW), enabling untethered operation, as discussed in more detail for the second prototype.

A prototype fitted with an electronics backpack (e.g., configured for autonomous or untethered operation) had approximate overall dimension of 15 mm×15 mm×5 mm, including an electronics backpack.

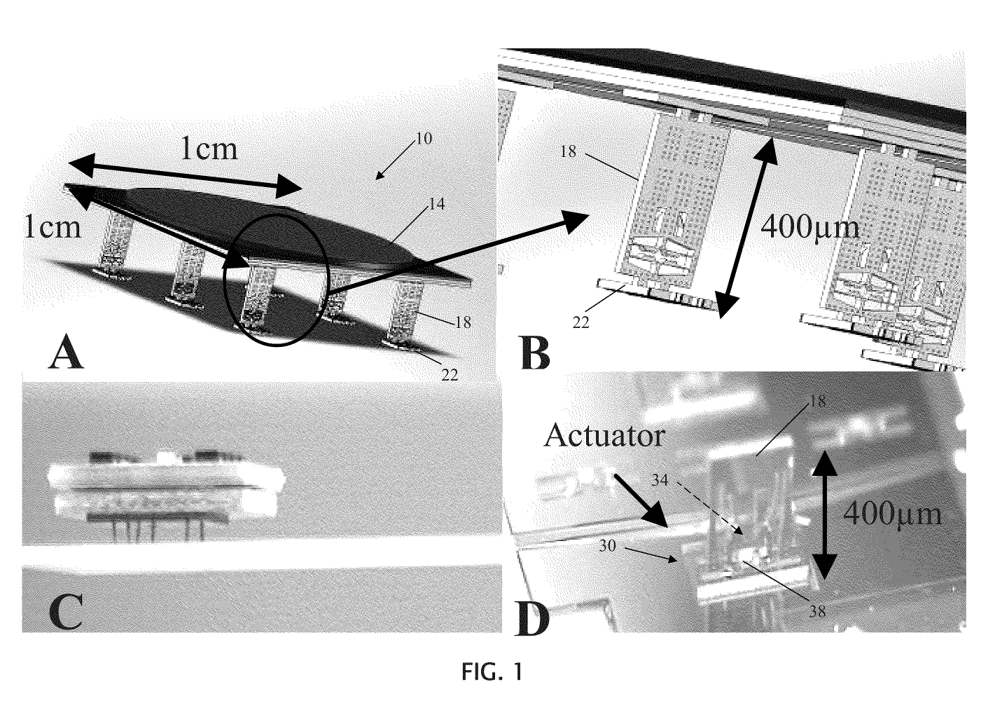

Referring now to the drawings, and more particularly to FIGS. 1A-1D, a microrobot 10 is shown. Embodiments of microrobot 10 may be referred to in this disclosure interchangeably as robot 10 or ARRIpede 10. FIG. 1A depicts a computer-generated solid model of a prototype of robot 10 without an electronics backpack (described in more detail below). In the embodiment shown, robot 10 comprises a body 14 and six legs 18, with each leg being coupled to the body 14 at an upper end of the leg, and terminating at a lower end with a boot 22. While legs 18 are described as having upper and lower ends, the upper and lower designations do not limit the orientation of robot 10. For example, if the robot 10 is placed on its “back” with the legs extending upward from the body (e.g., in a belly-up configuration), then the end of the leg that is coupled to the body may still be referred to as the upper end. As shown, in this embodiment, body 14 is substantially square and has outer dimensions of about 1 cm×1 cm. The shape and/or size of robot 10 is not limited by this example, and in other embodiments, robot 10 may be configured to have any suitable shape and/or size. For example, body 14 can be configured to have a shape that is, or is substantially, rectangular, triangular, circular, irregular, elongated, and/or any other suitable shape. By way of another example, body 14 can be configured to have a length and/or width of any suitable dimension (e.g., substantially and/or entirely equal to, less than, greater than, or between any of about: 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, or more cm).

Although legs 18 are shown in FIG. 1A as being in two rows of three legs each, robot 10 can comprise any suitable number of legs (e.g., equal to, greater than, less than, or between any of: 3, 4, 5, 6, 7, 8, 9, 10, 11, 12, 13, 14, 15, 16, 17, 18, 19, 20, 30, 40, 50, 60, 70, 80, 90, 100, 200, 256, 300, or more. Further, in the embodiment, shown the DOF of each actuator 34 is linear along an axis (e.g., forward/back axis), and the axis of at least one actuator 34 is substantially parallel to the axis of at least one other actuator 34 (e.g., at least two actuators 34 can be actuated in parallel directions). More particularly, in the embodiment shown, the axes of all actuators 34 are substantially parallel to each other. In other embodiments, legs 18 can be actuatable in any suitable direction or configuration. For example, a row of legs on the left of the robot body can be actuatable in a forward direction, and a row of legs on the right side of the robot body can be actuatable in a backward direction, such as, for example, to more readily facilitate rotation of the robot. By way of another example, a robot can be provided with one or more legs that are actuatable forward/backward relative to the body and one or more legs that are actuatable in a direction that is rotated relative to the longitudinal axis of the robot body (e.g., four legs at 0°, one leg at 90°, and one leg at 270°), such, as for example, to more-readily facilitate turning and/or lateral motion. Rotated legs can be positioned at any suitable angle to the longitudinal axis of the robot body, such as, for example, at about or equal to, less than, greater than, between any of, or at any interval between any of: 5, 10, 15, 20, 25, 30, 35, 40, 45, 50, 55, 60, 65, 70, 75, 80, 85, 90, 120, 135, 150, 180, 225, 270, and 360 degrees. Additionally, although robot 10 is shown with a single body 14, other embodiments can comprise one or more bodies 14 (e.g., pivotally coupled or otherwise articulated relative to one another).

FIG. 1B depicts an enlarged view of robot 10 depicting legs 18 and boots 22 in more detail. As shown, in this embodiment, each leg 22 has a length (or height) of about 400 μm. In other embodiments, legs 18 can be configured to have any suitable length (e.g., substantially and/or entirely equal to, less than, greater than, or between any of about: 10, 20, 30, 40, 50, 60, 70, 80, 90, 100, 200, 300, 500, 600, 700, 800, 900, 1000, 1200, 1400, 1600, 1800, 2000, 2500, 3000, 3500, 4000, 5000, or more μm). Additionally, legs 18 can be configured to have a length that is a percentage of a dimension of the body. For example, in the embodiment shown, the length of legs 18 is approximately 4% of the longest dimension of the body (e.g., 400 μm relative to 1 cm). In another embodiment, body 14 can be as small as 1 mm×1 mm with legs 18 as short as, for example, 10 μm. The size of the legs may depend on factors such as, for example: (1) moment-carrying capacity giving them torsional strength, and (2) the resonant frequency of the leg-actuator assembly, which may limit the maximum attainable velocity. Boots 22 can have any suitable dimension (e.g., 100 μm×100 μm).

FIG. 1C depicts a robot 10 including an electronics backpack or module 26 coupled to actuator 34 and configured to actuate actuators 34 to sequentially move legs 18 relative to body 14 (e.g., parallel to the plant of body 14 without necessarily increasing the distance, if any, between each leg 18 and body 14). As described in more detail below, electronics backpack 26 is configured such that if actuators 34 are actuated to sequentially move legs 18 at a rate, current is time-multiplexed to actuators 34 at a faster rate than the rate of the sequential movement of legs 18. In the embodiment shown, electronics backpack 26 comprises a power module (e.g., including a voltage booster and a current regulator, as described in more detail below). In other embodiments, and as described in more detail below, the electronics backpack can also include a controller and/or a battery. The controller and battery were not included in the initial prototype depicted. Electronics backpack 26 is described in more detail below. FIG. 1D depicts a bottom view of a thermal prismatic joint 30 with an electrothermal actuator 34 and socket 38, shown with a leg 18 coupled to the electrothermal actuator via a socket 38. Leg 18 is shown without a boot 22. In some embodiments, boots 22 are omitted and/or coupled to legs 18 after legs 18 are coupled to actuators 34.

As such, in the embodiment shown, robot 10 comprises: body 14; a plurality of actuators 34 coupled to body 14, the plurality of actuators each actuatable in a single degree-of-freedom (DOF) (e.g., along a forward/back axis); a plurality of legs 18 each coupled to a different actuator 34 and extending from that actuator 34 at a nonparallel angle (e.g., substantially perpendicular) relative to the DOF of that actuator 34. Additionally, as will be described in more detail below, robot 10 is configured such that if the robot is disposed with legs 18 extending upward from the body and a payload is supported by the legs above the body, actuators 34 can move legs 18 in a sequence to move the payload laterally (e.g., parallel to the plane of body 14). As will also be described in more detail below, robot 10 can also be configured such that if the robot is disposed on a suitable surface with legs 18 supporting body 14 above the surface, actuators 34 can move legs 18 in a sequence to move the robot across the surface.

Robot 10 can be (and in the present work was) constructed using what may be known in the art as 2½D assembly. The present prototypes of robot 10 were constructed using a 3D microassembly station, specifically, the μ³, located at UT Arlington's Texas Microfactory [16]. Legs 18 were fastened into compliant MEMS sockets located on the microrobot belly (e.g., lower side of body 14). These sockets were fabricated on electrothermal actuators having 1 DOF in-plane (e.g., having 1 degree-of-freedom movable parallel to the plane of body 14).

Simulation and experimental results for an inverted ARRIpede configured as “conveyor” carrying a 3.8 g payload match reasonably well, and the gait motion shows adequate smoothness and steering ability. Vertically assembled legs (legs that remain substantially vertical relative to the body and/or a supporting surface during use) improved the load carrying capacity of the robot, and the achievable robot precision. Such vertically assembled legs may also reduce the robot's ability to negotiate vertical obstacles and/or changes in elevation. Some examples of advantages of the present microrobots includes the ability to combine a large range of motion with high accuracy in positioning the body when slip locomotion ends, high joint strength, large payload capacity, and large force outputs.

### 1. ARRIpede (Robot) Overview

1.1 Microrobot Description and Motion Principle

In the embodiment shown, body 14 comprises what is known in the art as a microelectromechanical-systems (MEMS) die having a plurality of prismatic joints 30, each joint 30 including an actuator 34 and a socket 38 coupled to that actuator 34 and configured to be coupled to a leg 18, and where the DOF of each actuator 34 is in substantially the same plane as the DOF of each of the other actuators 34. More particularly, in the present prototyped embodiment, the ARRIpede microrobot 10 comprises an array of prismatic joints fabricated on a 1 cm×1 cm area Silicon on Insulator (SOI) die using deep-reactive-ion-etching (DRIE). In other embodiments, the robot and/or any of its various components can comprise (and/or be constructed from) metals (e.g., Nickel, shape memory alloy, etc), and/or any microactuator material that can be micromachined lithographically or that can generate in-plane motion (e.g., for the leg).

The robot exhibits adequate steering ability with 1 DOF designs (e.g., designs in which each actuator is actuatable to move a leg coupled to the actuator forward or backward along a single line that is parallel to the plane of the body), even without any legs or other locomotion structure that can provide lateral force output. The prismatic joints 30 comprise a chevron electro-thermal actuator 26 with a socket 38 configured such that a microsnap fastener can couple a leg 18 to the actuator (e.g., via a corresponding socket). In some embodiments, legs 18 can further be coupled to sockets 38 with ultraviolet (UV)-epoxy (e.g., in place of or in addition to the microsnap fasteners). Alternatively, thermal epoxies and/or reflowed metals can be used in place of UV-epoxy. Silicon legs 18 that are coupled (e.g., assembled) to these sockets with microsnap fasteners can be moved back and forth sequentially to create a stick-and-slip crawling motion. Various ARRIpede prototypes were designed to include 4, 6, or 8 actuated legs. Other embodiments can include any suitable number of legs.

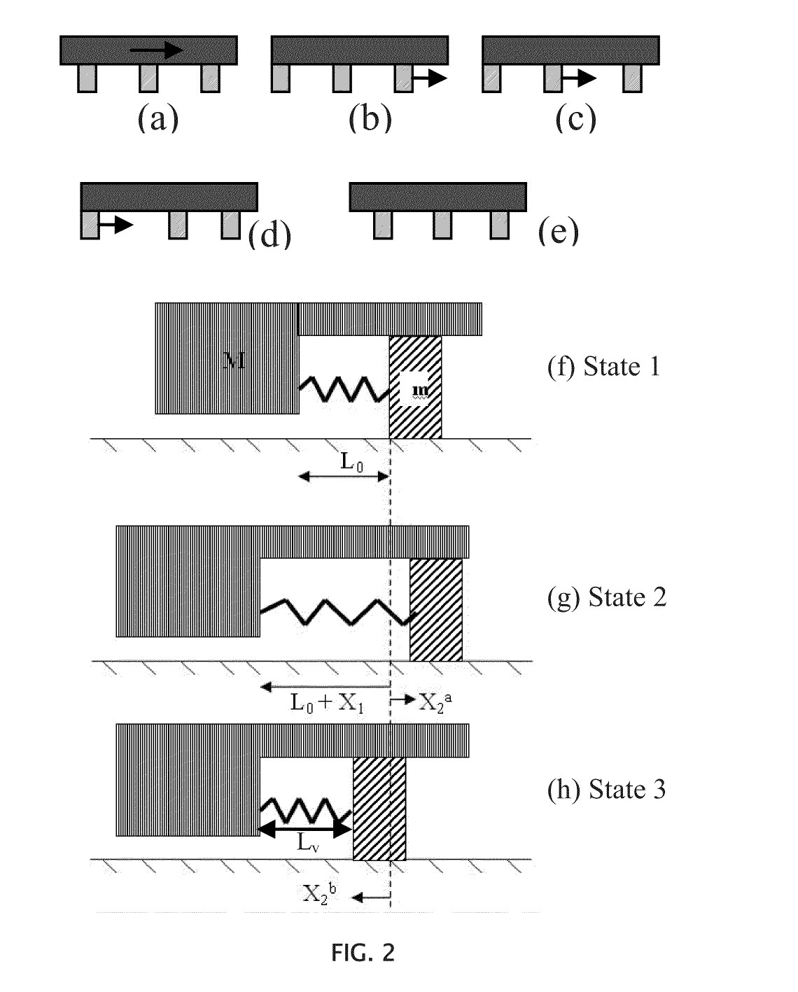

The principle of motion for the present embodiments is based on stick-and-slip motion, and is conceptually illustrated in FIG. 2. When actuated, a joint causes the robot body to move by a distance X₁ in a first direction and the leg to slip by X₂ in the opposite direction. The leg remains in this state until the joint is powered down, after which the leg is pulled back by the native stiffness of the actuator to a new position X₂¹. The magnitudes of displacements X₁, X₂, and X₂¹ generally depend at least on design and environmental parameters such as friction; actuator characteristics; and other factors such as robot mass, the number of legs, actuation cycle, etc. Dynamic analyses were conducted to determine achievable speeds based on various friction and payload conditions, which is described in more detail below.

1.2 Robot Leg Design

ARRIpede legs 18 comprise MEMS parts coupled (assembled) together. Such MEMS parts can include, for example, an actuated joint 34, a leg 18, and a boot 22. The first ARRIpede prototype was constructed without boots. In the prototyped embodiment, the body˜leg joint assembly includes a compliant microsnap fastener (or microfasteners) coupling the leg to the socket. These microfasteners are used to mechanically interconnect microparts, or to fixture them to a substrate. An example of a compliant, microsnap fastener suitable for use in embodiments (and used in the present prototyped embodiments) of the present robots is the Zyvex® connector, available from Zyvex Instruments, Richardson, Tex., USA, see [17]. Alternatively, other types of snap fasteners can be used and/or designed. Various microsnap fasteners will work, provided the compliance of the snap-fastener arms is adequate for the joint. Relatively large friction forces generated in the sockets 38 firmly hold parts (e.g., legs 18) during and after assembly. In addition to friction, and elastic deformation, sockets 38 can be (and are, in the prototyped embodiments) reinforced with ultraviolet (UV)-curable high viscosity epoxy to increase the force and moment carrying ability of the socket˜leg interface. The assembly and packaging process, and the experimental joint strength characterization, are described in more detail below.

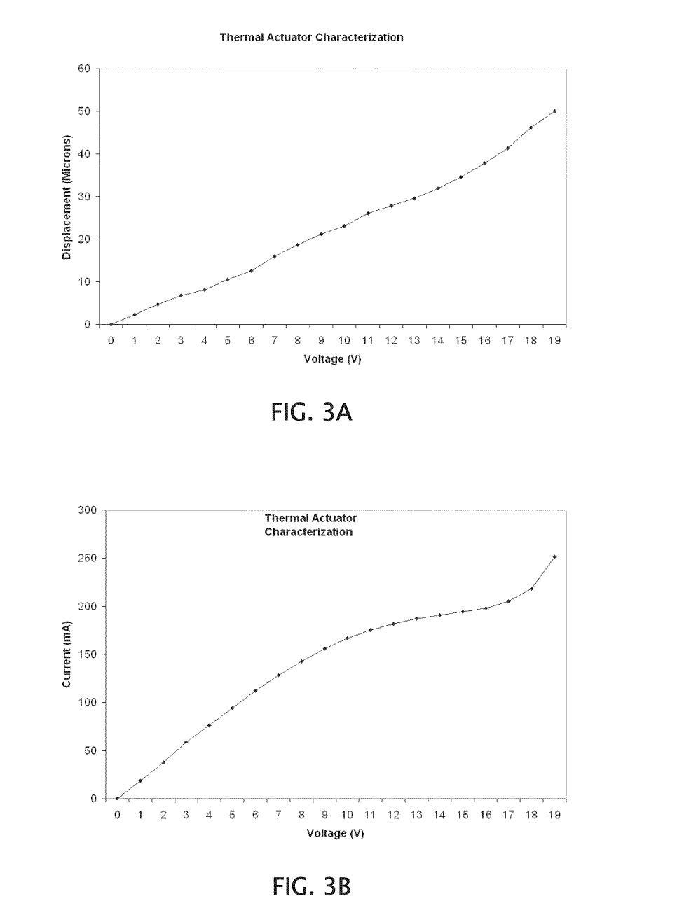

For the initial 4/6/8 legged ARRIpede designs, the chevron actuator was designed for a large horizontal displacement (e.g., up to 50 μm). For example, the electrothermal actuators used in the present prototypes produce a static deflection of up to 48 microns at 18V and 250 mA, as illustrated in FIGS. 3A-3B Advantages of the chevron actuators used in the prototypes, relative to other types of MEMS actuators include, for example, larger displacement, larger force, and smaller footprint or size. In addition, such actuators generally require, relative to at least some other types of MEMS actuators, larger current and some amount of time to cool down. Experimental data was collected at a voltage of up to 20 volts and a current of up to 140 mA.

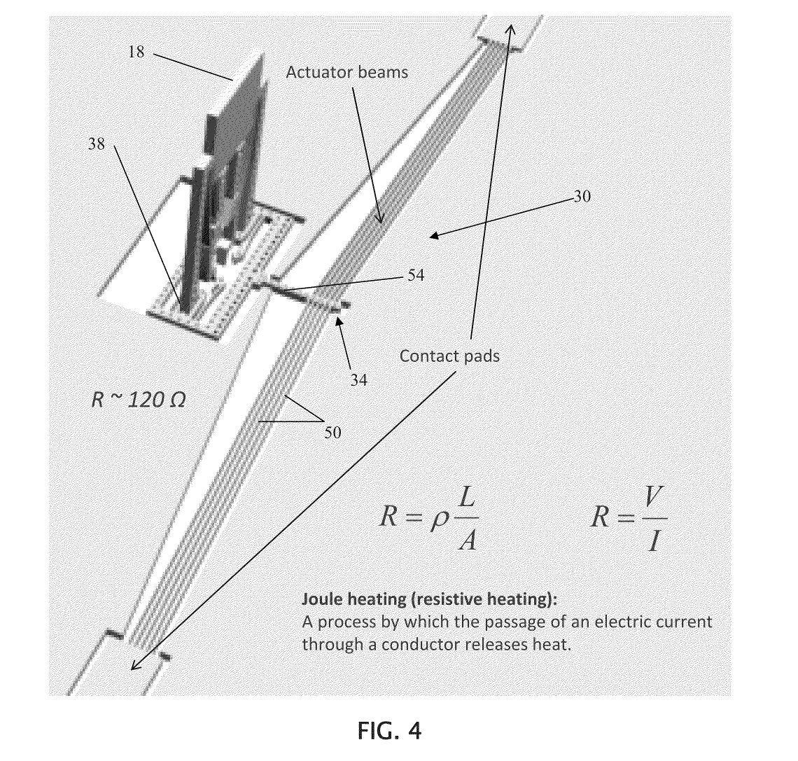

As illustrated in more detail in FIG. 4, actuators 34 used in the present prototypes each comprise seven pairs of 15 μm-wide, 1 mm-long, and 100 μm-thick beams 50. Beams 50 are separated by 10 μm and form an angle of 3.5° to a shuttle arm 54 that connects to socket 38. The displacement of an assembled socket was experimentally characterized using a Veeco-DMEMS optical profiler, available from Veeco Instruments Inc., Plainview, N.Y., USA. Electrothermal MEMS actuators, such as actuators 34, generally have a first-order dynamic transfer function between the input power and displacement [18]. The present designs exhibit a current draws of approximately: 50 mA at 10V input voltage and 18 μm steady-state displacements; and 250 mA at 19V input voltage with 48 μm displacements. The measured actuator bandwidth of actuator 34 is generally dictated by thermal effects (as opposed by mechanical resonance), and was measured to be 50 Hz. As described in more detail below, legs 18 of the robot 10 can be (and were) actuated in sequence to obtain appropriate gait motion.

### 2. Initial ARRIpede Static and Dynamic Analysis

2.1 ARRIpede Gait

In the prototyped embodiments, the ARRIpede was programmed to execute a ‘wave’ gait, according to the following sequence. In the first step, all joints are actuated concurrently in a first direction (e.g., actuated such that the body moves relative to the legs at substantially the same time) to cause the legs to stick and the body to move. Due to the relatively large power consumption of individual actuators 34, to reduce power consumption, the output current to each actuator was multiplexed such that, at any given instant, current is delivered to only one actuator. This reduces the effective output displacement by a factor of 1/√N, where N is the number of legs. In the second step, the joints are individually deactivated one after the other in a sequence (e.g., sequentially “powered down” or otherwise actuated such that the corresponding leg moves in a second direction opposite the first direction in the first step). In this way, the corresponding leg is retracted in an opposite direction to the slip. The dynamics of this repeated action involving the pushing forces and the forces due to inertia, friction, and damping cause the body to move forward and the leg to slip in the backward direction.

To better understand the wave gait, the following static force conditions can be considered. The microrobot parameters considered are: W, the mass of the robot; N, the number of actuated legs; and P, the number of passive “support” legs (legs that are not actuated). The static friction coefficient between the bottom of the leg and the surface that the robot walks on is μₛ₁, and, μₛ₂ is the static friction coefficient at the leg joint between the leg joint and the robot body. N is the number of actuated legs, and M is the number of passive “support” legs (never actuated), if any. The wave gait can be summarized by the following inequalities:

$$\begin{matrix}N {f}_{act} < \frac{( N + M ) ( {μ}_{s 1} + {μ}_{s 2} ) Wg}{( N + M )} , & ( 1 ) \\ N {f}_{act} > \frac{M ( {μ}_{s 1} + {μ}_{s 2} ) Wg}{( N + M )} , & ( 2 ) \\ {f}_{act} > \frac{( {μ}_{s 1} + {μ}_{s 2} ) Wg}{( N + M )} . & ( 3 ) \\ N {f}_{act} > \frac{P ( {μ}_{s 1} + {μ}_{s 2} ) Wg}{( N + P )} , & ( 4 ) \\ {f}_{act} > \frac{( {μ}_{s 1} + {μ}_{s 2} ) Wg}{( N + P )} . & ( 5 )\end{matrix}$$

Equations (1-3) suggest that when the ‘N’ active legs are actuated, they do not overcome the force due to friction. Thus the N+M legs do not slip. Equation (4) suggests that when the ‘N’ active legs are actuated, they cause the M passive legs to slip. Thereby, the robot body moves in the opposite direction to the actuation and the passive legs are dragged with it. Equation (5) is the required condition for the legs to be brought back to the initial condition one after the other. Thus, when the first leg is powered-off with the rest (N−1) in “ON” state, the leg slips back. For example; when P=5, N=10, W=3 g, μₛ₁=μₛ₂=0.33 (typical Silicon-Silicon coefficient of friction), equations (1)-(5) produce the following conditions for actuation force: (a) f_{act}<0.971 mN; (b) f_{act}>0.3234 mN; and (c) f_{act}>0.6468 mN. Thus, by designing an actuator that produces forces between 0.6468 mN and 0.971 mN, a locomotion gait can be generated, as depicted in FIGS. 2(a)-2(e). In particular, FIGS. 2(a)-2(e) depict the prototype ARRIpede wave gait over one “step.” That is, in FIG. 2(a), all legs are actuated at once such that the body moves forward (e.g., to the right); in FIG. 2(b), the right most leg is powered-down or released such that the rightmost leg slips to the right; in FIG. 2(c), the middle leg is released such that the middle leg slips to the right; in FIG. 2(d), the leftmost leg is released such that the leftmost leg slips to the right; and in FIG. 2(e), the body and legs have returned to the positions (relative to one another) of FIG. 2(a). FIGS. 2(f)-2(h) depict this operation of a single leg. In FIG. 2(f), the joint is un-actuated; in FIG. 2(g), N joints are actuated simultaneously such that the body is displaced by X₁ and the leg slips by X₂^{a}; and in FIG. 2(h), sequential de-powering of N actuators causes each leg to retract back by X₂^{b}—one after the other.

2.2 ARRIpede Dynamics

The ARRIpede dynamics were simulated to determine an optimum configuration for the microrobot and to evaluate the effects of different gaits. The ARRIpede parameters used for dynamic analysis using a lump model include: M, the mass of the robot payload including the mass of the other legs (e.g., for most practical purposes, the mass of the entire robot); m, the mass of each of the N legs; Lₒ, the unactuated prismatic joint length; Lᵥ, the net distance following de-powering (or powering down, or releasing) when the legs return to equilibrium; X₁, the displacement of the microrobot with a single step taken; X₂(=X₂^{a}+X₂^{b}), the total slip at each leg during a single step, where X₂^{a} is the slip backward during actuation, and X₂^{b} is the slip due to retraction when the joint is deactivated; K, the actuator stiffness; μ_{1d} and μ₁ₛ, the coefficients of dynamic and static friction, respectively, between the robot leg and surface on which the robot walks; μ_{2d} and μ₂ₛ, the coefficients of dynamic and static friction between the microsnap fastener socket and the robot belly; B₁, the damping coefficient between the leg and the floor; and B₂, the damping coefficient between the socket and the robot belly.

As shown in FIGS. 2(f)-2(h), there are generally three states of equilibrium during the ARRIpede gait cycle. In state 1, FIG. 2(f), the joints of the microrobot are in an “un-actuated” state.

In state 2, FIG. 2(g), N prismatic joints are actuated simultaneously. In this case, the equations of motion for the body with a Coulomb friction model can be written as:

M₁\ddot{x}₁+B₁\dot{x}₁NK(x₁+x₂^{a}−(Lₒ−Lᵥ))=μ₂Mg sgn(\dot{x}₁+\dot{x}₂), (6)

and the equilibrium condition for the leg becomes:

$$m {\ddot{x}}_{2}^{a} + {B}_{2} {\dot{x}}_{2}^{a} + K ( {x}_{1} + {x}_{2}^{a} - ( {L}_{o} - {L}_{v} ) ) = \frac{( {μ}_{1} + {μ}_{2} ) Mg}{N} sgn ( {\dot{x}}_{1} ) . \qquad ( 7 )$$

In state 3, FIG. 2(h), the legs are retracted or released sequentially, one after the other, and thus an equilibrium position is reached between the friction forces and the stiffness of the actuator. In this case,

$${F}_{fri\_ 2} = ( {F}_{2 \_push} - \frac{M}{m} {F}_{fri\_ 1} + \frac{M}{m} {F}_{1 \_push} ) ( 1 + \frac{M}{m} ) \qquad ( 13 )$$

Formulating the friction model at all states, it is important to consider both the absolute velocity of the leg and the relative velocity of the leg with respect to the body, and also the static and dynamic friction conditions. This determines the existence of static or dynamic friction forces at the leg˜floor interface and leg˜body interface.

Denoting: a₁=sgn(\dot{x}₁+\dot{x}₂), a₂=sgn(\dot{x}₂), define:

F₂_{_{—}}ₚᵤₛₕ=NK(x₁+x₂−Lᵥ)+B₁x₁, (9)

F₁_{_{—}}ₚᵤₛₕ=NK(x₁+x₂−Lᵥ)+NB₂x₂. (10)

We can then separate the following three friction conditions:

In the first condition: if abs(\dot{x}₂)>ε;(ε≈0),

F_{fri}_{_{—}}₁=−a₂μ_{1d}(M+Nm)g. (11)

This is the case when the leg is either slipping in state 2 or retracting in state 3. Also,

if abs(\dot{x}₁+\dot{x}₂)>ε

F_{fri}_{_{—}}₂=−a₁μ_{1d}Mg. (12)

This is the case when there is relative motion between the body and leg. Finally, if equation (11) is not valid at any given time, then:

$$m {\ddot{x}}_{2}^{b} + {B}_{2} {\dot{x}}_{2}^{b} + K ( {x}_{1} + {x}_{2}^{b} - ( {L}_{o} - {L}_{v} ) ) = \frac{( {μ}_{1} + {μ}_{2} ) Mg}{N} sgn ( {\dot{x}}_{1} ) . \qquad ( 8 )$$

In the second condition: if abs (\dot{x}₂)=0, i.e., when leg is stationary, and if abs(\dot{x}₁+\dot{x}₂)>ε, then the robot is moving forward, and thus, the dynamic coefficient of friction should be used:

F_{fri}_{_{—}}₂=−a₁Mgμ_{2d},

F_{fri}_{_{—}}₁=F₁_{_{—}}ₚᵤₛₕ−F_{fri}_{_{—}}₂ (14)

However, if abs(\dot{x}₁+\dot{x}₂)=0, denote:

F_{fri}_{_{—}}₂=F₂_{_{—}}ₚᵤₛₕ (15)

In the third condition: if this force is greater than the static friction force, i.e. if abs(F_{fri}_{_{—}}₂)>μ₂ₛMg, then

F_{fri}_{_{—}}₂=−a₂/Mgμ_{2d}, (16)

F_{fri}_{_{—}}₁=F₁_{_{—}}ₚᵤₛₕ−F_{fri}_{_{—}}₂. (17)

Finally, at any given time, if:

abs(F_{fri}_{_{—}}₁)>μ₁ₛ(M+Nm)g. (18)

then we can use the dynamic coefficient of friction to evaluate the friction force between the leg and the surface underneath:

F_{fri}_{_{—}}₁=−a₁(M+Nm)gμ_{1d} (19)

Upon actuation, the robot moves forward by a distance X₁, while the leg slips backward X₂^{a}. After this, the leg is retracted by a distance X₂^{b} when the joint is deactivated. It is to be noted that with the exception of the first step, the distance X₂^{a}=X₂^{b} during the subsequent steps (i.e., the legs can be expected to slip and retract by the same distance). The net actuation after a leg retracts is given by Lₒ−Lᵥ. For activation of a leg:

$$M {\ddot{x}}_{1} + {B}_{1} {\dot{x}}_{1} + N K ( {x}_{1} + {x}_{2}^{a} - {L}_{v} ) = {μ}_{2} Mg \cdot sgn ( {\dot{x}}_{1} + {x}_{2} ) \\ m {\ddot{x}}_{2}^{a} + {B}_{2} {x}_{2}^{′ a} + K ( {x}_{1} + {x}_{2}^{a} - {L}_{v} ) = \frac{( {μ}_{1} + {μ}_{2} ) Mg}{N} \cdot sgn ( {\dot{x}}_{1} ) \qquad ( 20 )$$

And for retraction of a leg:

$$m {\ddot{x}}_{2}^{b} + {B}_{2} {x}_{2}^{′b} + K ( {x}_{1} + {x}_{2}^{b} - {L}_{v} ) = \frac{( {μ}_{1} + {μ}_{2} ) Mg}{N} \cdot sgn ( {\dot{x}}_{1} ) \qquad ( 21 )$$

As noted above, dynamics were simulated to determine an optimum configuration for the microrobot and evaluate the effect of different gaits. For the simulation, parameters included: microrobot payload of 3.8 g (button battery-mass=0.9 g, electronics-mass=1.8 g, MEMS die-mass=1.1 g); joint stiffness of 185N/m, derived from a finite element analysis (FEA) electro-thermo-mechanical simulation of the thermal actuator and validated experimentally; viscous damping at the joints of B₁=B₂=0.1 Ns/m, N=6 (number of legs); L₀=1.7 mm; and the coefficients of friction at the leg-floor interface and at the joint-body interface were variables.

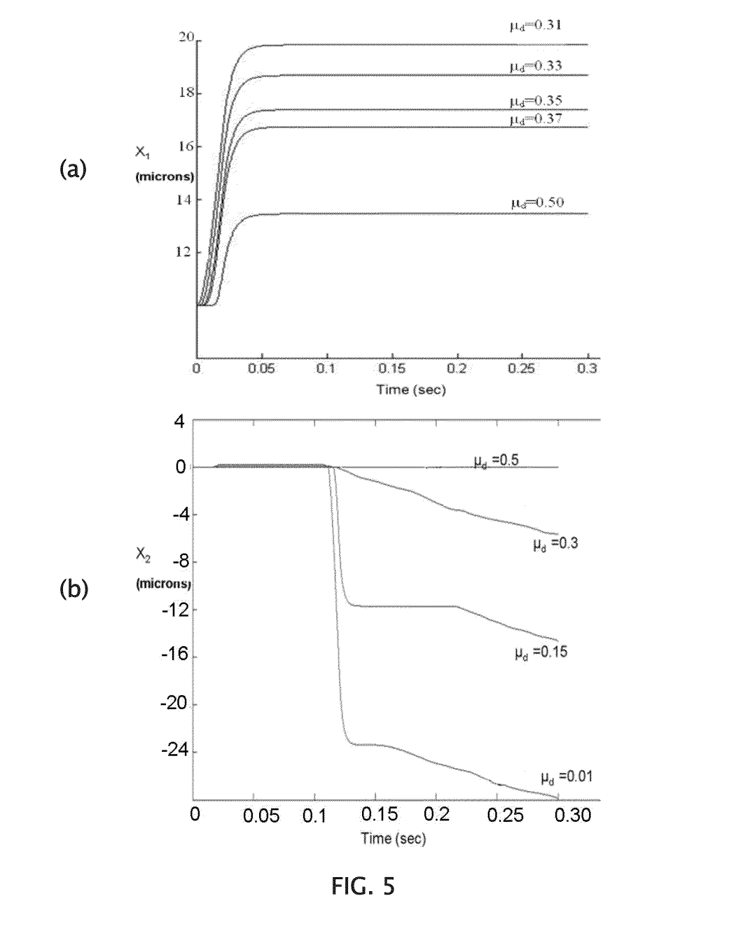

FIGS. 5(a) and 5(b) depict the variation in robot step size with varying friction coefficients. The drift observed in X₂, in FIG. 5(b), is a numerical artifact and can generally be overcome by the execution of a subsequent step in the gait sequence. The coefficients are equal if the robot slides across a silicon surface. In simulation, a static friction coefficient was selected to be slightly higher than the dynamic friction coefficient. In the prototyped embodiments tested or simulated on a Silicon surface, the coefficients of static and dynamic friction are substantially (if not entirely) the same at the leg˜body and leg˜ground. In particular, a prototype was experimentally validated for motion control on silicon surfaces.

From FIGS. 5(a) and 5(b), it was observed that with increased friction there is a reduction in the amount of leg retraction after each forward motion. This can reduce the robot speed. An input frequency of 45 Hz at 10 V with six legs, coupled with friction coefficients of 0.4 and 0.33 for static and dynamic friction, respectively, results in a displacement of 18.5 μm/step. This is in close agreement with the actual microrobot displacement under similar conditions, as listed in Table I. For input conditions of 25 V/180 mA, and actuation frequency of 65 Hz, the stick-slip model results in step size of 43 μm and a velocity of 2.795 mm/s. However, such a high velocity can impose high power requirements of the electronic backpack and additional energy conservation techniques can be useful to reduce power consumption.

### 3. Initial ARRIpede Prototype

3.1 Fabrication and Assembly

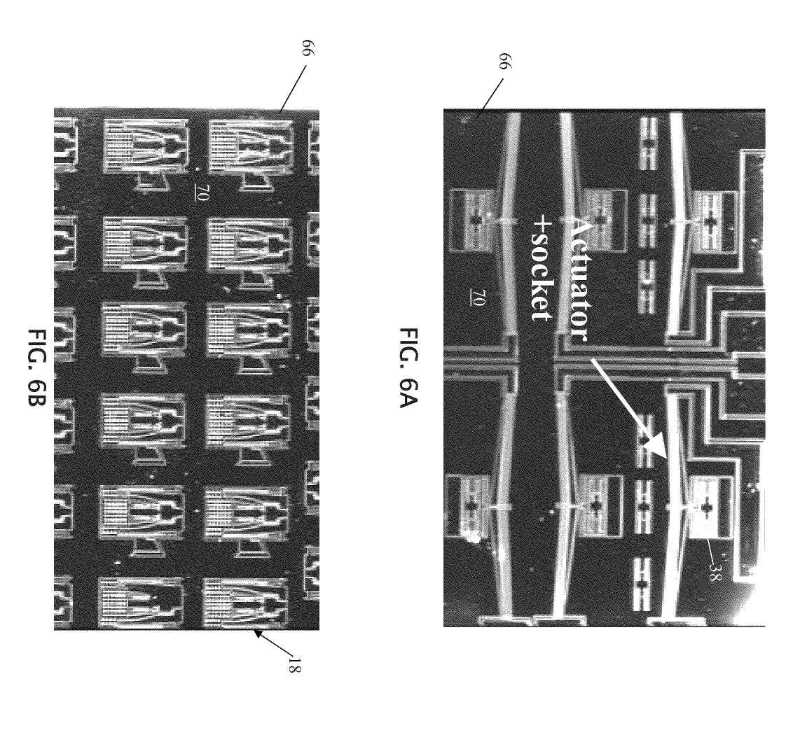

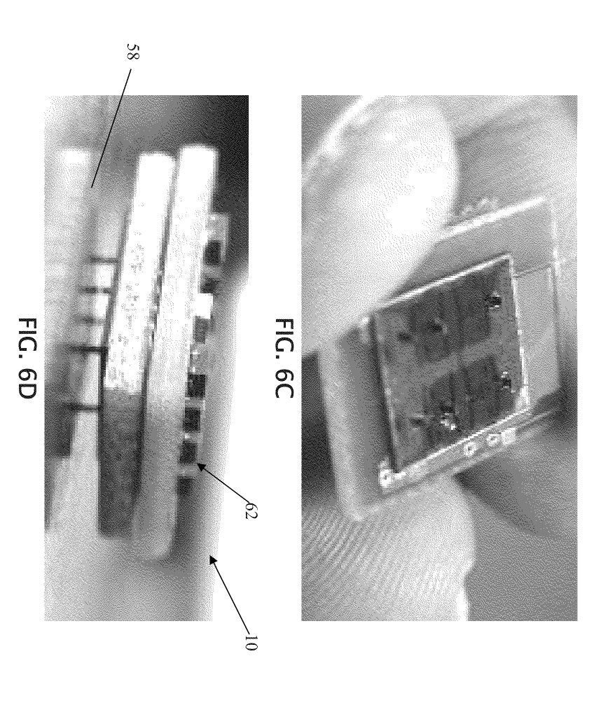

Referring now to FIGS. 6A-6E, various views are depicted of components of prototyped robot 10 and of an assembled robot 10. FIG. 6A depicts joint 30, including thermoelectric actuator 34 and socket 38. FIG. 6B depicts a sheet having a plurality of legs 18. In each of FIGS. 4A and 4B, the joints 30 and legs 18 were fabricated using a 100 μm thick device layer on (and are shown on) a Silicon-on-insulator (SOI) substrate. FIG. 6C depicts a bottom perspective view of a prototype of robot 10. FIG. 6D depicts a side perspective view of a prototype of robot 10 “standing” on (e.g., with legs 18 in contact with) a surface 58. In the embodiment shown in FIG. 6C, robot 10 is shown with a 2.9 g payload 62 (e.g., an electronics backpack). The die used to manufacture the prototype (the ARRIpede die) comprises in-plane electrothermal actuators (actuators that have 1 DOF parallel to the plan of body 14), as show in FIG. 6A, and vertically assembled legs (legs 18 that are substantially perpendicular to the plane of the body and the plane of the 1 DOF of the actuators).

The microparts (e.g., joints 30, legs 18) can be (and were) fabricated using deep reactive ion etching (DRIE) on silicon-on-insulator (SOI) wafers 66 with a 100 μm-thick device layer 70, as shown in FIGS. 6A and 6B. Legs can be (and were) de-tethered or removed from the die, and each coupled (assembled) to corresponding joints of the body of the robot. After assembly, legs 18 can be (and were) each glued to the corresponding socket (e.g., socket 38) with UV-epoxy and cured, to increase the strength of the joint. 3D microassembly of the ARRIpede prototypes, the μ³ multi-robot system [16] was used. The μ³ multi-robot system was configured with nineteen (19) DOF discrete stages arranged into 3 robotic manipulators (M₁, M₂, M₃) with 3 nm resolution, sharing a common 8 cm³ workspace. Three microscopes were used for calibration and visual servoing. The first two robotic manipulators M₁ and M₂ had seven DOFs each, and consisted of XYZ coarse and fine linear stages, with a rotation stage providing a terminating roll DOF (θ) axis which can be important for assemblies of 2½D MEMS components. The third (and central) robotic manipulator M₃ was a five-DOF robot consisting of an XYθ mechanism placed on a two-axis tilt stage. More information on the μ³ system can be found in [11]

3.2 Experimental Results

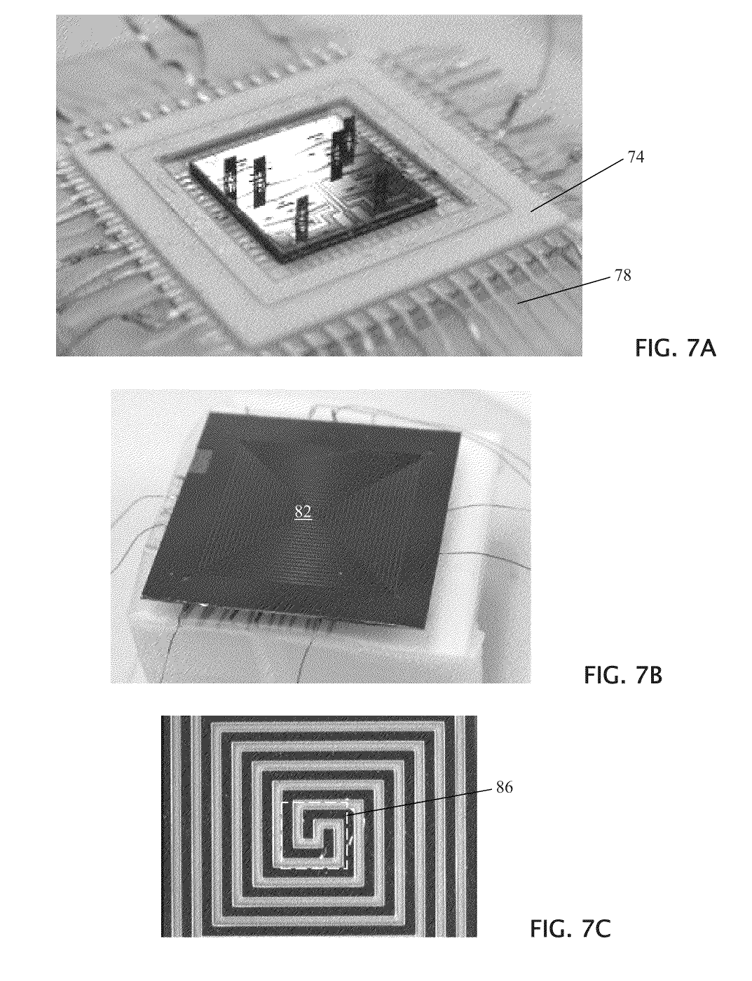

Referring now to FIGS. 7A-7C, this section describes experimentation that was undertaken to validate the ARRIpede concept. Because a power-and-controller board was not yet included in the initial prototype to make it autonomous, an inverted prototype of robot 10 with six legs 18 was used as a conveyor, as shown in FIG. 7A. The inverted prototype was powered and controlled remotely, via chip 74 and wires 78. During testing, the prototype 10 was actuated to manipulated a 4 cm×4 cm×1 mm silicon die 82 as a payload, as shown in FIG. 7B. Payload 82 was provided at its center with a feature 86 for tracking translation of the payload. Feature 86 was fabricated using the SOI DRIE process on the silicon payload 82. Payload 82 weighed approximately the same as a robot 10 supporting its own weight with an electronics backpack (about 4 g). Microcrawler legs 18 were actuated under varying amplitudes and frequencies to control the position of payload 82.

As conceptually illustrated in FIG. 8, the ARRIpede prototype tested had a six-legged configuration. The leg velocity, given by A₁f₁ (amplitude×frequency) can be (and was) controlled to steer the microcrawler and to compensate for lateral drift during straight line motion. The product of the amplitude with the frequency of actuation, which gives a measure of the leg velocity, was used as the control parameter to steer the robot. For example, when looking towards the direction of motion, consider the case when the legs on the right are actuated at higher velocity than the legs on the left, i.e.

A₁f₁<A₂f₂ (22)

where A_{1,2} represent the amplitude of motion, and f_{1,2} represent the frequency. Differential velocity between the two sides results in the robot steering left.

The rationale for the amplitude-frequency product controlling the velocity of the robot is counterintuitive, since electrothermal actuators are nonlinear. However, it was reasonable approximation because by cycling the gait motion at high frequencies, there is not enough time for the actuator to reach to its steady state, and instead the actuator reaches a value roughly proportional to the input frequency. As a result, it was expected that at frequencies close or higher to the thermal bandwidth (50 Hz), the attainable velocities are proportional to the square of the amplitude-frequency product. This effect was compared with experimental data shown in Table I. A maximum, unpredicted 1.55 mm/s speed was recorded in case #5 when actuated at 135 Hz and 10 V. Furthermore, it was expect that a doubling of the input voltage to 20V would cause even larger velocities, above 3 mm/s, as predicted by the simulation. Notice that the sideway drift (along Y) when the amplitude-frequency products on both sides of the robot are equal was relatively minimal, and was measured to be below 0.1 mm/s.

FIG. 9A illustrates longitudinal (e.g., forward) motion of payload 82 parallel to axes of actuation of the legs, in mm, for varying amplitude and frequencies; and FIG. 9B illustrates sideways or lateral drift perpendicular to axes of actuation of the legs, in mm, for varying amplitude and frequencies. More particularly, FIGS. 7A and 7B illustrate longitudinal and lateral displacement of payload 82 for several conditions of ARRIpede leg velocity. In the first condition, all legs were actuated to move with the same velocity. Combinations of frequency and amplitude resulting in similar velocities were experimented with, and the resulting displacement of the robot was verified experimentally. In the second condition, the set of legs on the left (when looking forward) were actuated at higher frequency-amplitude products than the set of legs on the right, and led to steering towards the right. In the third condition, the set of legs on the right (when looking forward) were actuated at higher frequency-amplitude products than the set of legs on the left, which led to steering towards the left. The amount of drift steering was similar for each of the second and third conditions.

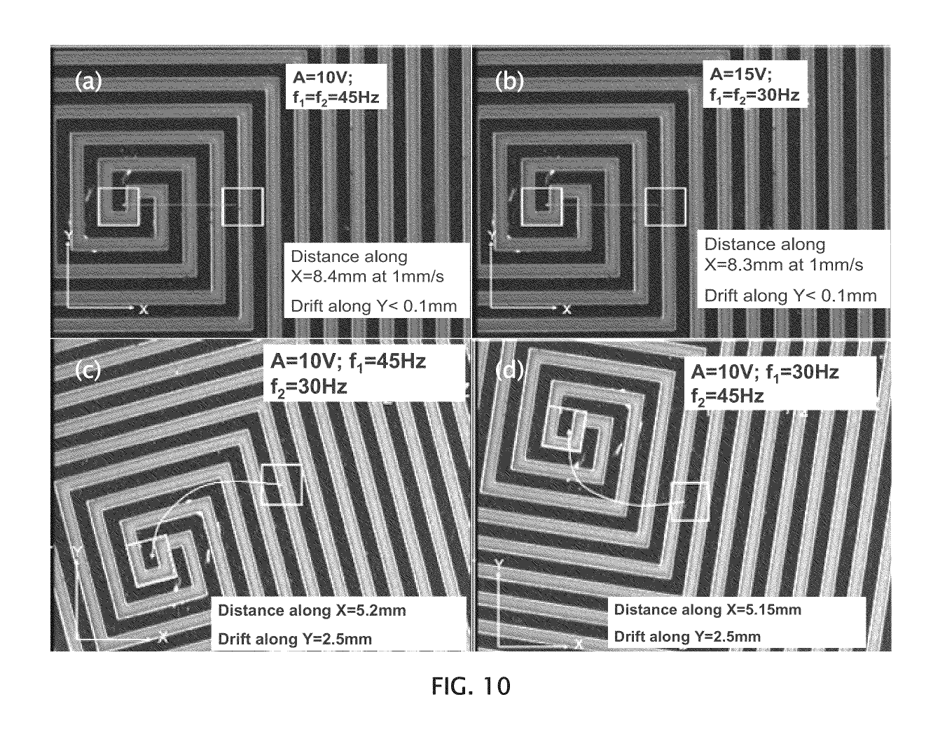

During the described experiments, the microscale feature 86 on top of payload 82 was tracked using a 0.7× microscope lens and IMAQ® machine vision software to determine the location of feature 86 as payload 82 moved. FIGS. 10(a)-10(b) depict forward motion of payload 82 motion for two different amplitude-frequency combination with the same amplitude-frequency products. FIG. 10(c) illustrates steering to the left with mismatched actuation frequencies, and FIG. 10(d) illustrates steering to the right with mismatched actuation frequencies. For the illustrated translations, the input voltage had a 20% duty cycle and was modulated between legs on a 1 kHz carrier. Thus, the effective frequency content was above the thermal resonance, even for case #1 in Table I. From the results in Table I, it can be seen that the velocity was not quite linearly related to the frequency-amplitude product, and that the translation velocity at 90 Hz was lower than the translation velocity at 45 Hz or 135 Hz. Additional factors, such as, for example, un-modeled thermal actuator effects, or bending mechanical resonance might account for the discrepancy. From the simulation results in FIG. 5, for the case when the robot is crawling over a surface with dynamic friction coefficient of 0.31, the body is displaced by approximately 20 μm per cycle. This amounts to a displacement of 9 mm in 10 seconds, which is close to the experimentally determined displacement in case #2.

TABLE I
Robot speed results from vision data for forward
motion, and the effect of the amplitude-frequency product.

| # | A₁ = A₂ (Volts) | f (Hz) | (Af)² | Forward Velocity (mm/s) | Velocity from simulation (mm/s) | $\frac{Af}{\sqrt{V}}$ |
|---|---|---|---|---|---|---|
| 1 | 10 | f1 = f2 = 15 | 22500 | 0.365 | 0.312 | 410 |
| 2 | 10 | f1 = f2 = 45 | 202500 | 0.84 | 0.832 | 535 |
| 3 | 15 | f1 = f2 = 30 | 202500 | 0.83 | 0.810 | 542 |
| 4 | 10 | f1 = f2 = 90 | 810000 | 0.74 | 0.790 | 1216 |
| 5 | 10 | f1 = f2 = 135 | 1,822,500 | 1.55 | 0.648 | 870 |

TABLE II
ARRIpede steering data

| # | A₁ (V) | f₁ (Hz) | A₂ (V) | f₂ (Hz) | (A₁f₁)² | (A₂f₂)² | ω rad/s |
|---|---|---|---|---|---|---|---|
| 1 | 10 | 45 | 10 | 30 | 202500 | 90000 | 0.062 |
| 2 | 10 | 45 | 10 | 15 | 202500 | 22500 | 0.075 |
| 3 | 10 | 15 | 10 | 45 | 22500 | 202500 | 0.078 |
| 4 | 10 | 30 | 10 | 45 | 90000 | 202500 | 0.057 |

3.3 Power Electronics

The ARRIpede microrobot power module and control electronics can be carried by embodiments of the microrobot as a “backpack” or module, such as is shown in FIG. 6D. The voltage regulator used for the prototype measures 1.5 cm×1.5 cm and weighs 1.1 g. It consists of a Switch Mode Power Supply that can supply up to 27 V output from a 3 V battery source. The current source circuit weighs 0.7 g and can supply 300 mA current switched into 8 channels (actuators, though the prototype included only 6 legs). Together with the 1.1 g SOI die mass, they amount to 2.9 g. As shown in FIGS. 1C and 6D, the legs had no problem supporting this payload. For the experiments described above, the circuits were used with the prototype, but the switching logic and 3V power source were supplied externally via wires 78.

In the “belly-up” configuration described above, the leg actuation sequence was driven using a Labview®-based VI switching between the miniaturized channel amplifier. The thermoelectric actuator used in this prototype typically requires up to 15 V at 200 mA during actuation. If all legs were simultaneously, it would impose a high power consumption rate. As a result, each cycle of the carrier pulse-width modulation (PWM) signal into a sequence of high frequency (1 kHz) pulses sent to different actuators. As such, even though macroscopically it appears that all legs are actuated simultaneously, at any given instant, there is current flowing to only one actuator. In this way, the load on the power electronics is reduced by 1/N, where N is the number of active legs, at a cost of 1/√N to the amplitude of motion. The total power consumption is thus equivalent to one electrothermal actuator (e.g., 500 mW maximum at 10V). This further suggests that if the robot is operated at a 5 mW power draw, speeds can be achieved in excess of 0.3 mm/s. For a typical small supercapacitor, this should ensure over 10 minutes of continuous operation before recharging is required.

3.4 Leg Joint Strength Determination

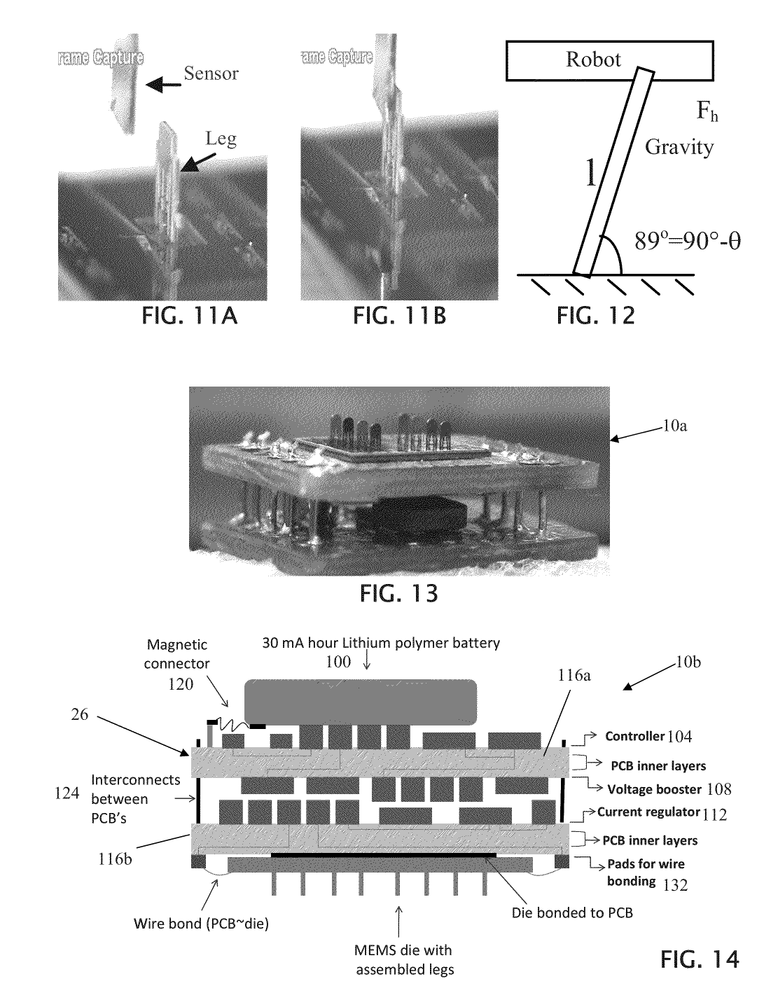

Experiments were also performed on the ARRIpede prototype leg assembly to determine leg joint strength. A SensorOne® AE-800 series micro-cantilever (available from SensorOne Technologies Corporation, Sausalito, Calif., USA) was used to for these experiments. This sensor was mounted onto the M₁ robot in the μ³ system, and the sensor was pushed against an assembled leg to obtain force measurements, as shown in FIGS. 11A and 11B. During these experiments, the average joint strength of the epoxy bonded joint was measured to be 28.5 mN. The joint strength influences the maximum payload carrying capacity of the robot. Angular “pitch” misalignment given by θ≈1° can also arises during microassembly. Payload of a robot can be determined by the weight that will seize or prevent actuation (which should occur before joint failure). FIG. 12 illustrates a leg misaligned by up to 1° during assembly. The component of the robot mass+payload acting perpendicular to this joint is given by:

$${F}_{h} = \frac{M}{N} g cos ( θ ) . \qquad ( 23 )$$

Therefore, for a joint strength of 14 mN (e.g. including a 0.5 safety factor), it can be estimate that a six-legged ARRIpede robot with a leg joint misalignment of θ=1° can carry a total mass M≈9 g, which is more than twice the weight of the robot. Experimental static results obtained by “inverting” the robot in a wire-bonded package confirmed that the robot would be able to support its target electronic backpack and a small battery for autonomous operation.

### 4. Autonomous (Untethered) ARRIpede Prototype

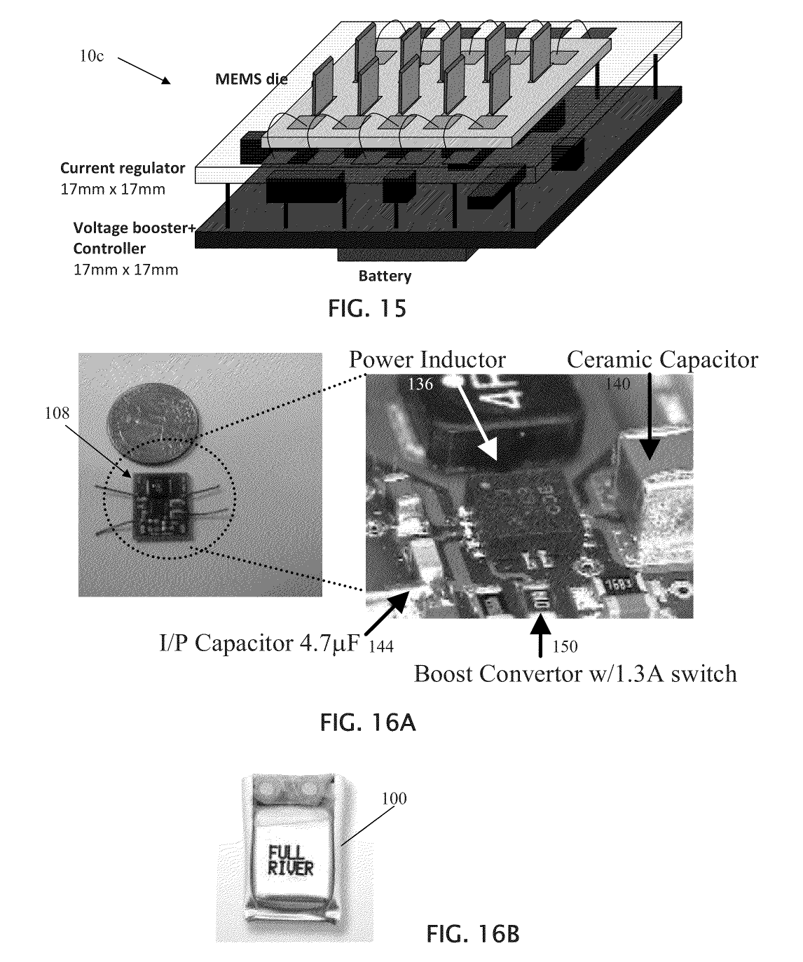

Referring now to FIGS. 13-15, various embodiments of the present robots 10 are shown. More particularly, FIG. 13 depicts an autonomous (un-tethered) prototype of robot 10a having eight legs (e.g., two rows of four legs each); FIG. 14 depicts a side view of an autonomous prototype of a robot 10b having sixteen (16) legs (e.g., two rows of eight legs each); and FIG. 15 depicts a bottom perspective view of a computer-generated solid model of a prototype of robot 10c having ten legs (e.g., two rows of five legs each). Prototypes of robot 10 were also constructed, as discussed in preceding sections of this disclosure, having six legs (e.g., two rows of three legs each). The prototyped embodiments share a number of common elements, and it should be understood that any of the elements of a robot or robot 10 described in this disclosure may be applied and/or used in other embodiments of the present robots.

For an autonomous (un-tethered) prototype with an electronics backpack, a number of packaging goals were identified, including, for example, suitably attaching or coupling the die or body 14 to the electronics backpack 26; bonding wires to appropriate contacts on body 14 and electronics backpack (e.g., 8-16 interconnects between electronics backpack 26 and actuator pads); housing and/or supporting electronics configured to actuate the legs (e.g., controller, voltage booster, current regulator(s), Li-polymer battery, etc.); and provide necessary electrical and other interconnects between electronics, while keeping total weight under 8 g.

As noted above, robot 10 comprises a body 14, a plurality of legs 18 (with or without boots 22), and an electronics backpack 26. Body 14 comprises a plurality of actuated joints 30 each comprising an actuator 34 and a socket 38 configured to be coupled to a leg 18. In the embodiments shown, electronics backpack 26 comprises a battery 100, a controller 104, and a power module (that includes a voltage booster 108, and a current regulator 112), all disposed on one or more (two, as shown) printed circuit boards (PCBs) 116. In the embodiment shown, controller 104 and voltage booster 108 are coupled to a first or upper PCB 116a; and current regulator 112 is coupled to a second or lower PCB 116b. In the embodiment shown, battery 100 is physically coupled to first PCB 116a by way of any suitable mechanical coupling such as, for example, adhesive, UV-epoxy, solder, etc. In the embodiment shown, battery is also electrically couplable (e.g., directly and/or indirectly) to the controller, voltage booster 108, and current regulator 112, by way of a magnetic connector 120. Electrical and/or physical coupling (e.g., interconnection) between first and second PCBs 116a and 116b is provided by conductive and/or non-conductive interconnects 124 (e.g., wires and/or the like) extending between PCBs 116a and 116b. In the embodiment shown, second PCB 116b also include conductive pads 128 to which wires 132 from body 14 (e.g., for powering the actuators) can be, and are shown, coupled.

Embodiments of the present controller 104 can be, for example, a microcontroller, and can be configured (and is configured, as shown) such that if coupled to actuators 34 and to a power source (e.g. the battery and/or the power module), the controller can be activated to sequentially actuate actuators 34 at a rate by time-multiplexing current to actuators 34 at a faster rate than the rate of sequential actuation of the actuators 34. Controller 104 can also be configured such that if the rate of sequential actuation of the actuators is reduced by a factor of ten, the rate of power consumption of the actuators is reduced by a factor of about one hundred (e.g., between 80 and 100, between 90 and 100, between 95 and 100, etc.).

In the embodiments shown, body 14 (including joints 30, actuators 34, and sockets 38) and legs 18 were constructed and assembled in substantially the same ways as described for the six-legged prototype above (e.g., DRIE on SOI, microfasteners, vertical or vertically assembled legs, Si MEMS electrothermal actuators on “belly” of body 14, 2½ D construction, stick-slip based motion, etc.). The six-legged prototype of robot 10 with electrical backpack included the following specifications: volume of 1.5 cm×1.5 cm×1 cm; three DOFs (XYθ); total weight of 4.5 g; payload carrying capacity of 9 g; and velocity of 1˜3 mm/s.

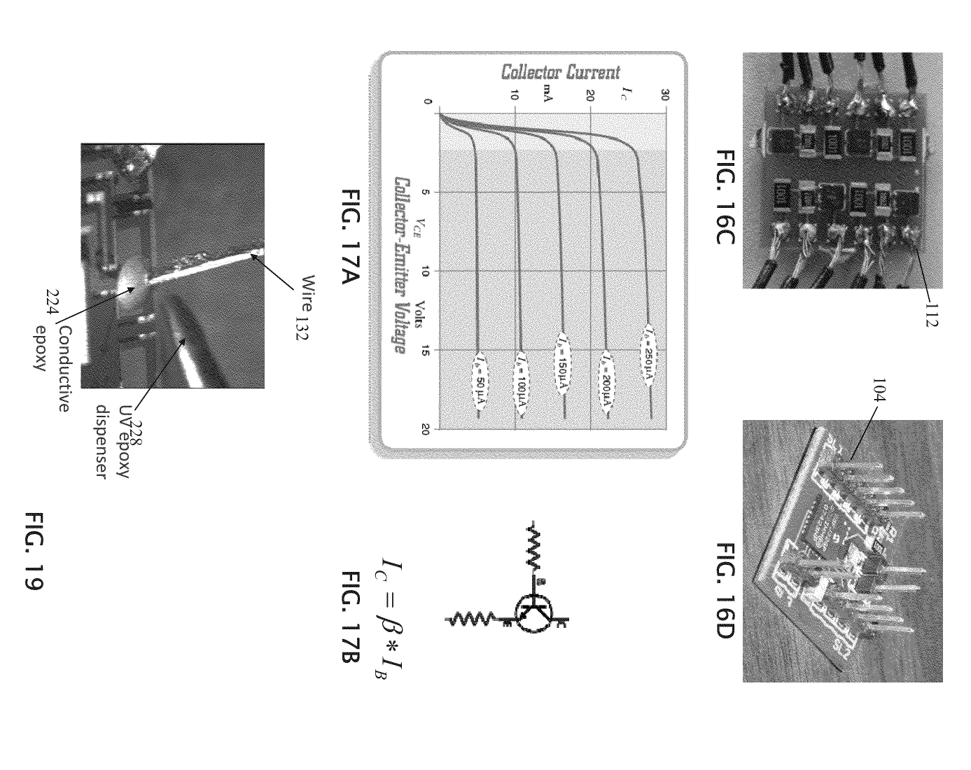

Referring now to FIGS. 16A-16D, individual components are shown of the electronics backpack 26 of the autonomous prototype of robot 10. FIG. 16A depicts the voltage booster (amplifier) 108. In the embodiment shown, voltage booster 108 comprises a power inductor 136, a ceramic capacitor 140, a 4.7 μF I/P capacitor 144, and a boost converter 148 (e.g., with 1.3 A switch), all of which are coupled to a booster PCB 152. In the embodiment shown, voltage booster 108 weighs about 1.1 g, is configured for an input voltage of 2.5-6 V, and is configured for an output voltage of up to 27 V. In other embodiments, voltage booster 108 can be configured with any suitable components and/or its components can be coupled directly to one a PCB 116 of electronics backpack 26.

FIG. 16B depicts a Lithium-polymer battery 100 used for the autonomous prototype of robot 10. Battery 100 was manufactured by Fullriver Battery new Technology Company Ltd. in Quangzhou, China, and available from various distributors in the USA. Other LiPO batteries are also available. In the embodiment shown, battery 100 weighs about 1.2 g, and is rated for 30 mAh, 3.7 V, and 600 mA. The autonomous prototype was configured such that battery 100 supplied power to voltage booster 108 at 3.7 V/600 mA, and voltage booster 108 received and outputted increased voltage and reduced current (e.g., 10 V/125 mA). Another battery option is a 40 mAh/3.7 V/600 mA battery weighing 2.5 g. FIG. 16C depicts a current regulator 112 used for the autonomous prototype of ARRIpede robot 10. Current regulator 112 is configured to output current of up to 300 mA, at input voltage of 3 V and input current of about 500 μA. Current regulator 112 is also configured with eight output channels on a six-bump micro SMD chip-size package of about 2.5 mm×2.5 mm, with a weight of about 0.7 g.

FIG. 16D depicts a controller 104 used for the autonomous prototype of robot 10. Controller 104 is includes a DSP microcontroller (dsPIC33FJ32GP202) circuit configured to generate the required input actuation profile and generate the leg sequence to perform the wave gait of the robot. Controller 104 is configured for an operating voltage of 3-3.6 V (e.g., 3.3 V), and weighs 1.1 g. The output current of controller 104 is 4 mA. As such, for the transistor portion of current regulator 112 shown in FIGS. 17A and 17B, I_{B} is 4 mA, and I_{C} is 220 mA. Controller 104 measures about 6 mm×6 mm in a quad flat no-leads (QFN) configuration. Controller 104 is also configured with 28 pins, 21 I/O pins; program memory of 32 kB; CPU speed of 40 MIPS, 16 bit architecture; a 7.37 MHz internal oscillator, sixteen (16) 16-bit PWM resolutions, three 16-bit (1×32-bit) timers, and peripherals including one UART, one SPI, one I²C; four/two Capture/Compare/PWM peripherals. Controller (e.g., microcontroller) 104 can be configured such that if the it is activated to sequentially actuate the actuators, the microcontroller can sequentially actuate the actuators to consume 100 to 400 milliamps (mA) (e.g., equal to, less then, greater than, or between any of: 100, 120, 140, 160, 180, 200, 225, 250, 275, 300, 325, 350, 375, 400 mA) of current at a voltage of eighteen to twenty volts across the actuators.

Battery 100 can supply power continuously to a single actuated actuator for approximately six minutes. Thus, high power consumption would result if all legs were actuated simultaneously. To counteract this, every cycle of the PWM were divided into high frequency (1 kHz) pulses, with each sequential pulse send to a different actuator. At any given instant, current flows to only one actuator. Thus, reducing the total power consumption at each instant.

To provide these high-frequency pulses, electronics backpack 26 (e.g., controller 104) was configured to generate shifted multiple PWM signals. In particular, the clock was configured for 40 MHz, timer#2 and the compare unit were configured to generate a 76 Hz control signal at 40% duty cycle, timer#3 was configured to select when to turn off an output, and timer#1 was configured to multiplex the outputs when more than one output is on. The production of appropriate control signals is also described in more detail below.

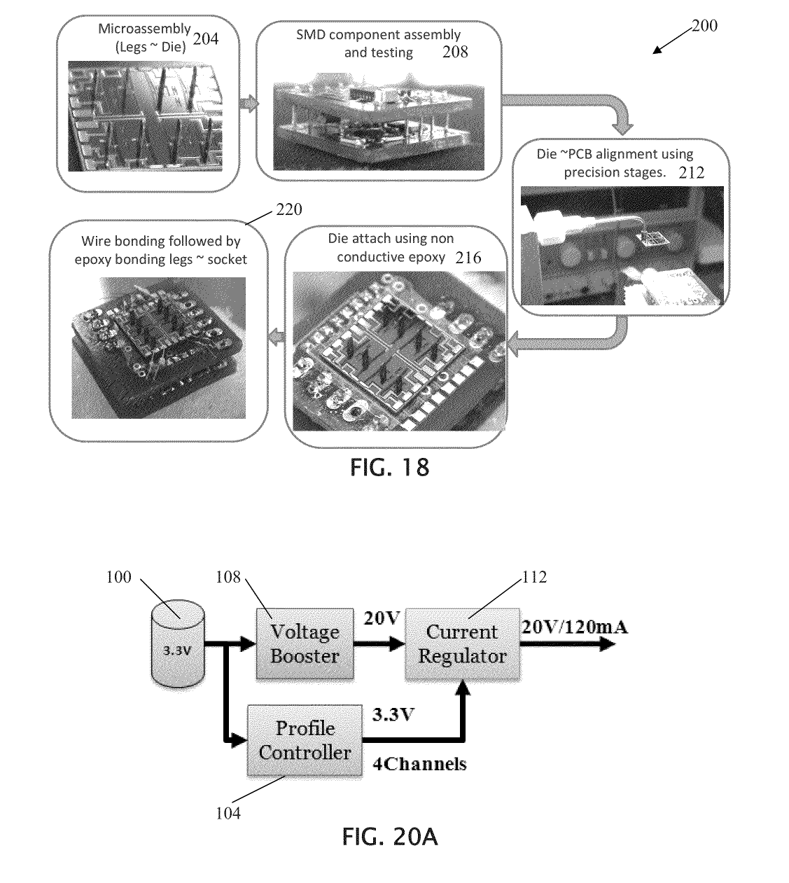

Referring now to FIG. 18, a flowchart is shown depicting one embodiment (and the embodiment used for the autonomous prototype) of a method 200 for constructing a robot 10. As shown, method 200 comprises a first step 204 that includes microassembly of the legs 18 (with or without boots 22) and body (or die) 14. In some embodiments, step 204 also includes manufacturing the legs and joints (e.g., via DRIE on SOI, as discussed above). In other embodiments manufacturing of the legs and joints is completed in a separate step and/or by another. Method 200 comprises a step 208 that includes SMD component assembly and/or testing (e.g., assembly and/or testing of the components of electronics backpack 26). In the embodiment utilized for the autonomous prototype, step 208 includes coupling the components (e.g., PCBs 116a and 116b, battery 100, controller 104, voltage booster 108, current regulator 112, etc.), such as, for example, by way of PCB interconnects 124 and other suitable connectors (e.g., solder) and the like. In some embodiments, electrical insulation (e.g. tape, epoxy, etc.) is applied between battery 100 and top PCB 116a, between controller 104 and top PCB 116a, between voltage booster 108 and top PCB 116a, and/or between current regulator 112 and bottom PCB 116b. In some embodiments, one or more of controller 104, voltage regulator 108, and current regulator 112 are constructed on the respective PCB 116 such that they are integral to the respective PCB 116 (e.g., such that inner layers of the PCB provide electrical insulation).

Method 200 comprises a step 212 that includes aligning body 14 relative to electronics backpack 26 (e.g., relative to bottom PCB 116b). In the autonomous prototype, body 14 was aligned at the center of bottom PCB 116b, but in other embodiments, body 14 can be aligned in any suitable position relative to electronics backpack 26 (e.g., such that the weight of electronics backpack 26 is more evenly distributed among legs 18). Method 200 comprises a step 216 that includes coupling body 14 to electronics backpack 26 (e.g., to bottom PCB 116b). In the embodiment shown (in the embodiment used for the autonomous prototype), body or die 14 can be coupled to bottom PCB 116b by way of nonconductive epoxy. In some embodiments, step 212 and step 216 can be performed substantially simultaneously.

Method 200 comprises a step 220 that includes bonding wires 132 to conductive pads 128. In the embodiment shown (in the embodiment used for the autonomous prototype), wires 132 are coupled to pads by way of UV-epoxy (epoxy that is curable with UV light). As illustrated in FIG. 19, a free end of each wire 132 is positioned in contact with or adjacent to a corresponding pad 128 and conductive epoxy 224 is applied to such that the epoxy 224 is in contact with both the wire and the pad (e.g., from an epoxy dispenser 228). Step 220 also includes bonding each leg 18 to its respective socket 38 with epoxy, as noted above. Wires 132 can comprise copper (Cu) and/or have, for example, a diameter of 30˜120 μm (e.g., 35 μm). For the autonomous prototype, the coupling technique used active gripping and epoxy. Some embodiments can comprise solder. For example, wire 132 can be soldered to pad 128 to hold it in place as epoxy 224 is applied. Epoxy 224 comprised thermal conductive epoxy (e.g., to help ensure functional electrical contact). UV-curable epoxy adds strength to the joint. Pads 128 were isolated from the actuators and sockets on body 14 to prevents epoxy 224 from flowing into the actuators and sockets. Some advantages of using UV-epoxy include that the pads and wires can remain at room temperature during coupling or joining; that the resulting joints had high strength and low resistance (e.g., ˜5 ohm/joint); that the wires and pads can be coupled at oblique angles; that a metal (Au) layer is not required for bonding; and that bonding is enabled over distance (e.g., if wire 132 does not physically contact pad 128, conductive epoxy 224 can bridge the distance while enabling electrical communication. During manufacture of the autonomous prototype, the process took approximately 25 minutes per wire.

In some embodiments of method 200, step 204 is performed after one or more of steps 208-220. For example, in some embodiments of method 200, electronics backpack 26 is assembled, body 14 is coupled to electronics backpack 26, and legs 18 are then coupled to body 14.

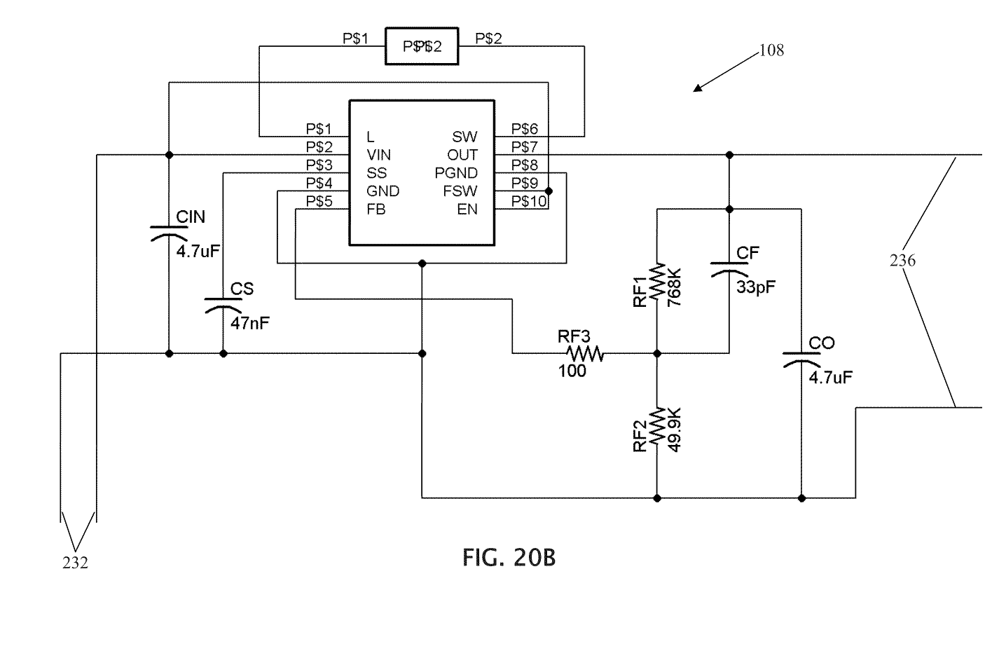

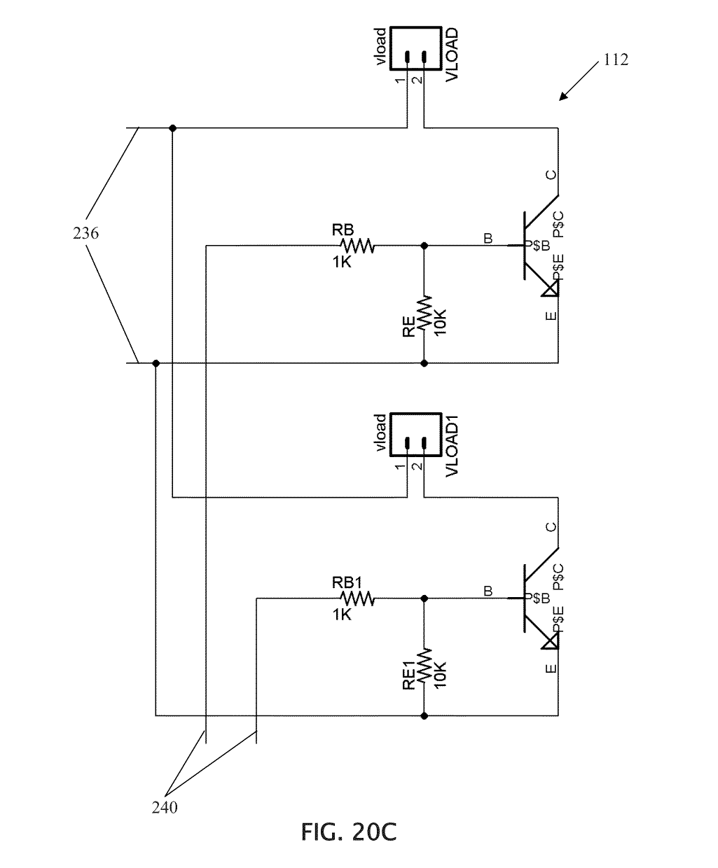

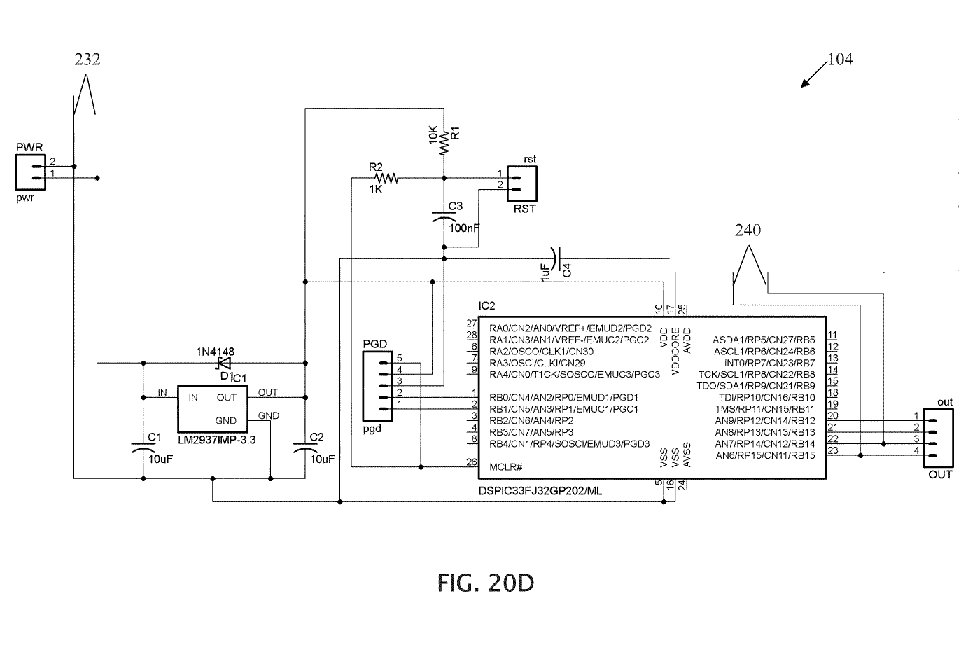

Referring now to FIGS. 20A-20D, schematics are shown of certain components of electronics backpack 26. More particularly, FIG. 20A depicts battery 100, controller 104, voltage booster 108, current regulator 112, along with a simplified indication of their connection to one another. FIG. 20B depicts a schematic of one embodiment of voltage booster 108. Connections 232 couple voltage booster 108 and controller 104, and connections 236 couple voltage booster 108 and current regulator 112. FIG. 20C depicts a schematic of one embodiment of current regulator 112. As noted above, connections 236 couple current regulator 112 and voltage booster 108. Connections 240 couple current regulator 112 and controller 104. FIG. 20D depicts a schematic of one embodiment of controller 104 and a portion of the current regulator 112 depicted in FIG. 20C. As noted above, connections 232 couple controller 104 and voltage regulator 108, and connections 240 couple controller 104 and current regulator 112.

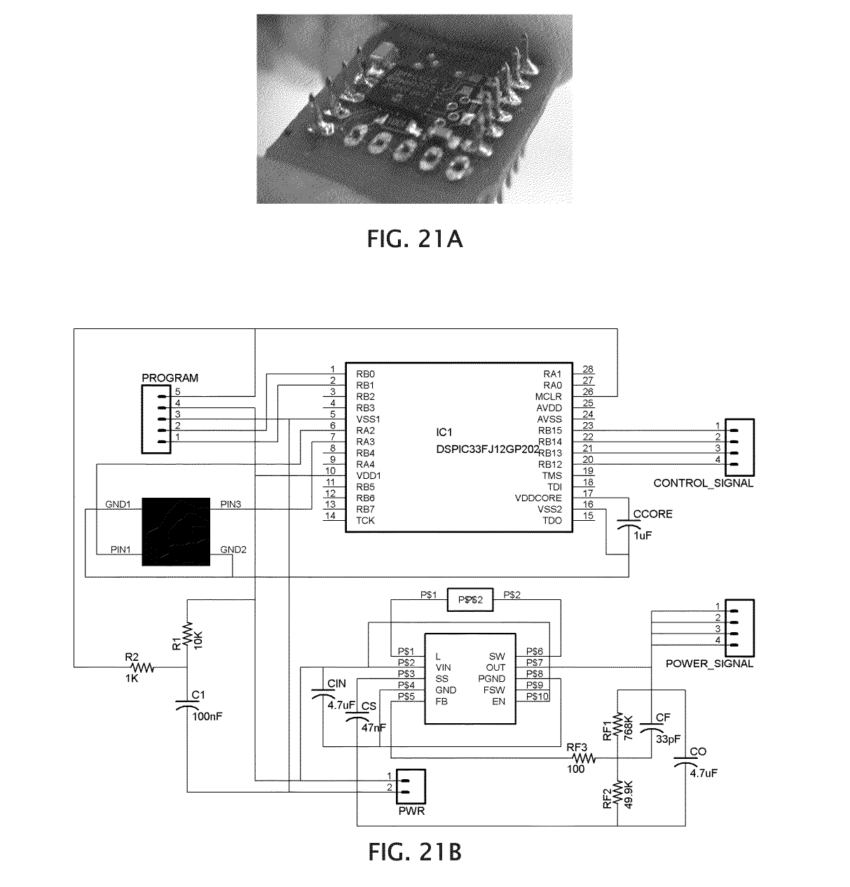

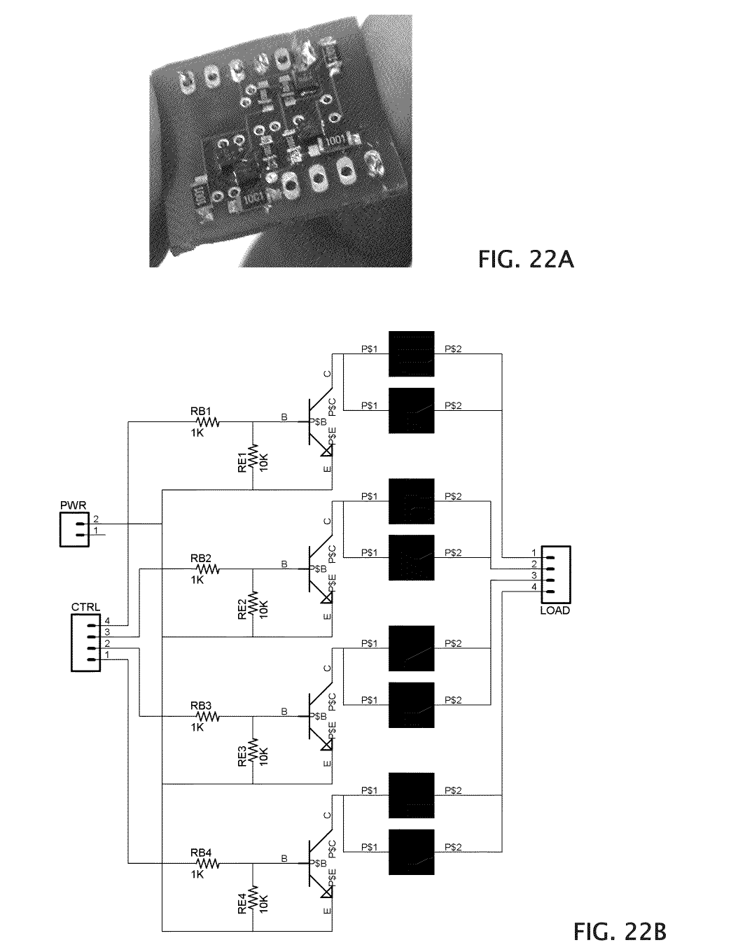

Referring now to FIGS. 21A, 21B, 22A, and 22B, alternative embodiments of the components of electronics backpack 26 are shown. FIG. 21A depicts controller 104 and voltage regulator 108 assembled on a single PCB having dimensions of about 17 mm×17 mm. FIG. 21B depicts a schematic of the controller 104 and voltage booster 108 of FIG. 21A. FIG. 22A depicts current regulator 112 and pads 128 assembled on a PCB having dimensions of about 17 mm×17 mm. FIG. 22B depicts a schematic of current regulator 112 of FIG. 22A.

In various other embodiments, the components of electrical backpack 26 can be distributed on PCB's 116 to facilitate assembly and repair, and/or to distribute the weight across the electronics backpack for more-even loading of legs 18 (e.g., to balance robot 10).

### 5. Autonomous Prototype Dynamic Model

For purposes of predicting and controlling motion of the autonomous prototype, a more complete model of the stick-slip motion of the robot was developed.

5.1 Vector Fields for Motion Control and Robot Dynamics

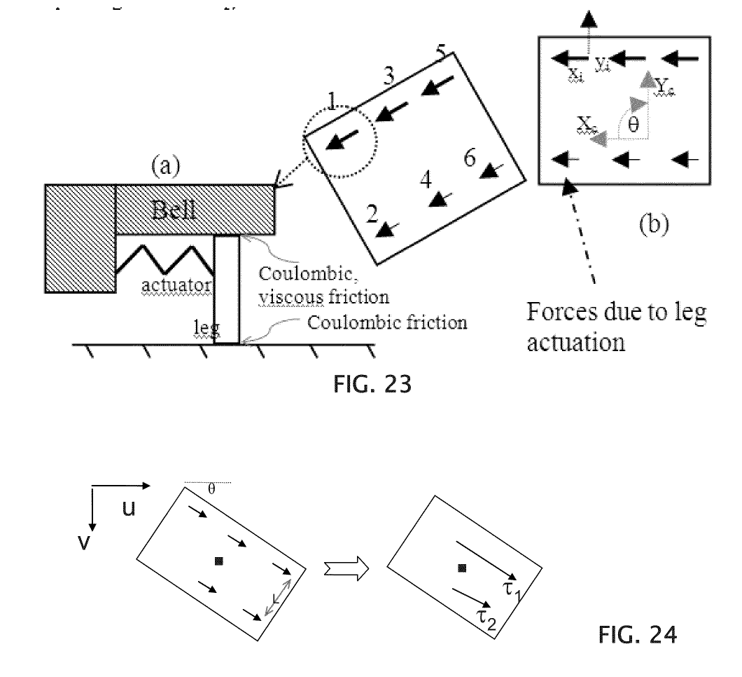

The state vector representing the ARRIpede position in a planar world coordinate frame is:

$$\begin{matrix}{q}_{body} = [ \begin{matrix}{q}_{body\_trans} \\ {q}_{body\_rot}\end{matrix} ] \\ = {[ \begin{matrix}{X}_{c} & {Y}_{c} & {θ}_{c}\end{matrix} ]}^{T}\end{matrix} \qquad ( 24 )$$

where, (X_{c},Y_{c}) are the Cartesian coordinates of the center of the robot and ‘θ_{c}’ is its orientation. In addition to the position of its body, the robot consists of N legs, which displace relative to the body. Their positions relative to a coordinate frame fixed onto the robot body is:

$$\begin{matrix}{q}_{legs} = [ \begin{matrix}{q}_{1} & {q}_{2} & , , , & {q}_{N}\end{matrix} ] \\ = [ \begin{matrix}{x}_{1} & {x}_{2} & {x}_{3} & … & {x}_{N} \\ {y}_{1} & {y}_{2} & {y}_{3} & … & {y}_{N} \\ {θ}_{1} & {θ}_{2} & {θ}_{3} & … & {θ}_{N}\end{matrix} ]\end{matrix} \qquad ( 25 )$$

where qᵢ represents the state of leg i. The leg is assembled to the actuator and makes contact with the belly and the bottom surface. The stiffness along the direction of actuation is 180 N/m compared to 380 N/m along the perpendicular in-plane axis. Referring to FIG. 23(b), denoting the actuation direction as xᵢ, and due to the fact that the prismatic electrothermal actuators are designed with high stiffness along the yᵢ and θ_{I} directions, it should be safe to assume.

yᵢ(t)=const,i=1 . . . N,and

θ₁=θ₂= . . . =θ_{N}=const≈0 (26)

Next, a quantitative relationship between the actuation pattern in the leg array and the resulting motion of the body is derived.

5.2 Autonomous Prototype Leg Dynamics

The dynamic model is represented as,

$${m}_{leg} {\ddot{q}}_{leg ( i )} + {m}_{leg} g [ ( {μ}_{d 1 \_c} + {μ}_{d 2 \_c} ) {q}_{leg ( i )} + ( {μ}_{d 1 \_v} ) {\dot{q}}_{leg ( i )} = {ψ}_{i} ( {A}_{k} {f}_{a} {f}_{m} ) , \qquad ( 27 )$$

where m_{leg} is the mass of each leg, μ_{d1-c} and μ_{d2-c} are the Coulombic friction coefficients between the leg˜belly and leg˜ground, respectively, μ_{d1-v} is the coefficient of viscous friction, Ψ is the force generated due to the electrothermal expansion of the actuator and τ is the net force generated by the i^{th} leg during one actuation cycle.

The force Ψ generated at specific electrothermal actuator locations is controlled by the input signal amplitude, gait frequency and the frequency at which the PWM's are multiplexed as shown in equation (28):

Fₖᵢ=Ψᵢ(Aᵢ,fₐᵢ,fₘᵢ) (28)

and can be represented by a first order transfer function as shown below [18]:

$${F}_{ki} ( s ) = \frac{b}{s + 2 π {f}_{mi}} {A}_{ki}^{2} \qquad ( 29 )$$

The basis for equation (29) is due to the fact that the thermal bandwidth of electrothermal actuators is typically an order of magnitude smaller than the first mechanical resonant mode and can often be represented using a first order pole transfer function. Also, the actuation displacement profile follows a nonlinear quadratic profile proportional to the square of the amplitude due to Joule heating effects. This relationship and the constant b can be fitted to the force model shown in equation (29) using experimental data.

The net force and moment at center of mass due to the discrete force field is the resultant of leg forces on the left and right sides of the robot, respectively:

$${τ}_{1} = {\sum }_{i = 1}^{{N}_{left}} {ψ}_{i} ; \\ {τ}_{2} = {\sum }_{i = 1}^{{N}_{right}} {ψ}_{i} ; \qquad ( 30 )$$

in which N_{left} and N_{right} are the number of legs on either side of the center of mass. The linear force and angular torque acting on the robot body due to two vectors τ₁ and τ₂ can be represented by:

$${τ}_{lin} = {τ}_{1} + {τ}_{2} , \\ {τ}_{ang} = \frac{L ( {τ}_{1} - {τ}_{2} )}{2} , \qquad ( 31 )$$

where L is the distance between the two longitudinal arrays of legs, as shown in FIG. 24.

5.3 Autonomous Prototype Body Dynamics

The robot dynamics can be recovered using the Euler Lagrange approach, and reduced to a second order differential equations with kinematic constraints given by:

$$\begin{matrix}{m}_{body ( 3 \times 3 )} {\ddot{q}}_{body} = {R}_{3 \times 2} [ \begin{matrix}{τ}_{1} \\ {τ}_{2}\end{matrix} ] + [ \begin{matrix}sin {θ}_{c} \\ - cos {θ}_{c}\end{matrix} ] λ & ( 32 ) \\ {m}_{body ( 3 \times 3 )} = [ \begin{matrix}{m}_{body} & 0 & 0 \\ 0 & {m}_{body} & 0 \\ 0 & 0 & {I}_{zz}\end{matrix} ] ; \\ {R}_{3 \times 2} = [ \begin{matrix}cos {θ}_{c} & cos {θ}_{c} \\ sin {θ}_{c} & sin {θ}_{c} \\ \frac{L}{2} & - \frac{L}{2}\end{matrix} ] & ( 33 )\end{matrix}$$

where, ‘λ’ is a Lagrange multiplier, R_{3×2} transforms the forces from the local coordinate frame to the body shown in equation 33[29, 30]. From equations (31) and (32) we can write:

$${\ddot{x}}_{c} = \frac{{τ}_{lin}}{{m}_{body}} cos {θ}_{c} + \frac{λ}{{m}_{body}} sin {θ}_{c} , \\ {\ddot{y}}_{c} = \frac{{τ}_{lin}}{{m}_{body}} sin {θ}_{c} + \frac{λ}{{m}_{body}} cos {θ}_{c} \\ {\ddot{θ}}_{c} = \frac{{τ}_{ang}}{{I}_{zz}} \qquad ( 34 )$$

If v and w are the linear and angular velocities of the mobile robot in global frame, their relation to the robot body coordinates becomes:

$${\dot{q}}_{body} = [ \begin{matrix}cos {θ}_{c} & 0 \\ sin {θ}_{c} & 0 \\ 0 & 1\end{matrix} ] [ \begin{matrix}v \\ w\end{matrix} ] \qquad ( 35 )$$

Differentiating equation (35) we get,

\ddot{x}=−v\dot{θ}_{c} sin θ_{c}+\dot{v} cos θ_{c}.

ÿ=v\dot{θ}_{c} cos θ_{c}+\dot{v} sin θ_{c}.

\ddot{θ}_{c}=\dot{w}. (36)

Comparing equations (34) and (36) we can represent the dynamic variables as shown in equation (37);

$$[ \begin{matrix}\dot{v} \\ \dot{w} \\ \dot{{x}_{c}} \\ \dot{{y}_{c}} \\ \dot{{θ}_{c}}\end{matrix} ] = [ \begin{matrix}\frac{1}{{m}_{body}} \\ 0 \\ 0 \\ 0 \\ 0\end{matrix} ] {τ}_{lin} + [ \begin{matrix}0 \\ \frac{1}{{I}_{zz}} \\ 0 \\ 0 \\ 0\end{matrix} ] {τ}_{ang} + [ \begin{matrix}0 \\ 0 \\ v cos ( θ ) \\ v sin ( θ ) \\ w\end{matrix} ] \qquad ( 37 )$$

Equations (29), (30), and (37) represent the dynamics of the ARRIpede crawling with inputs and outputs represented in equation (37). The advantage of this 5^{th} order model over the previous model (described above) is that this 5^{th} order model allows implementation of closed loop control, as described in more detail below. As such, the present controllers (e.g., microcontrollers) can be configured to sequentially actuate one or more actuators at a first frequency and one or more other actuators at a second frequency to steer embodiments of the present robots (e.g., microrobot) according to a fifth-order vector model, such as, for example, the model described with reference to at least equations (29), (30), and (37).

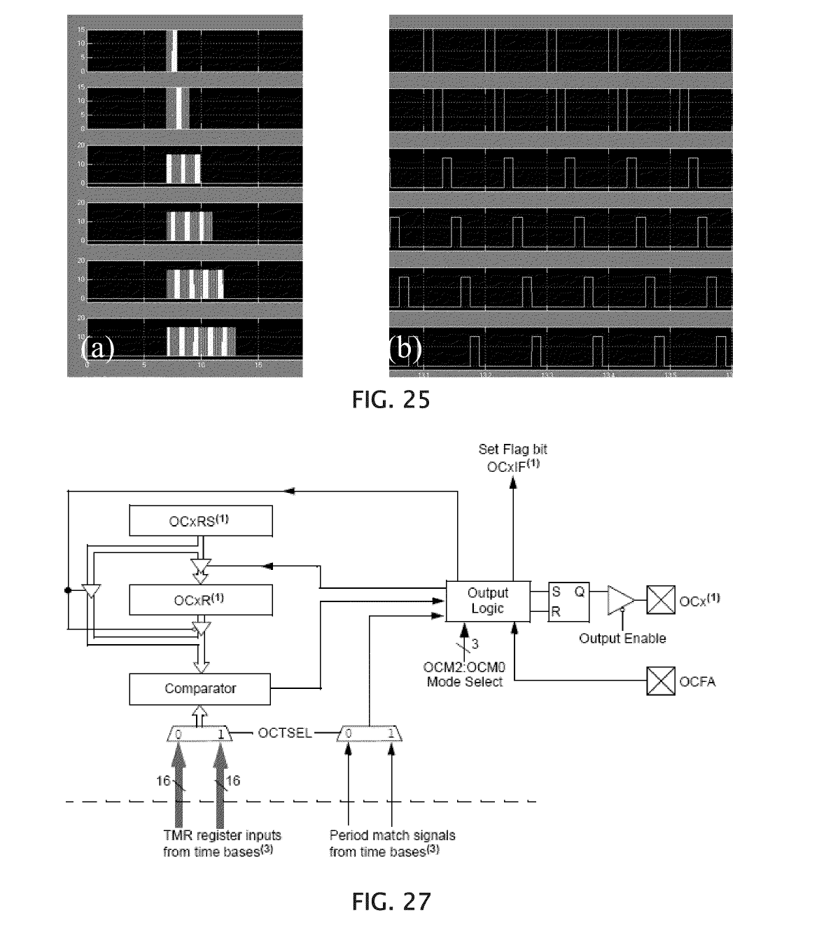

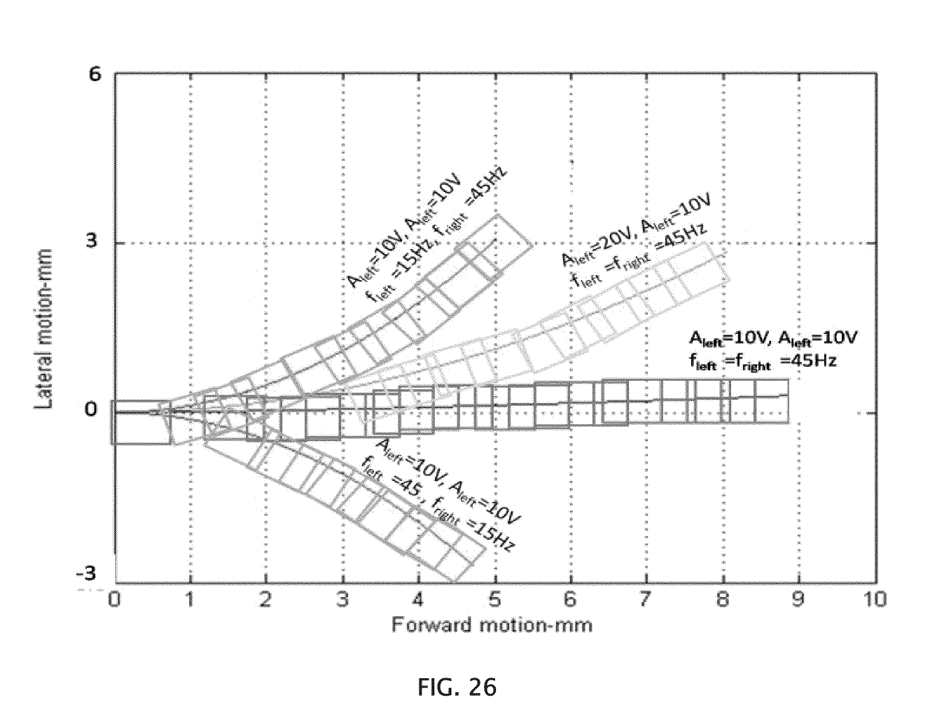

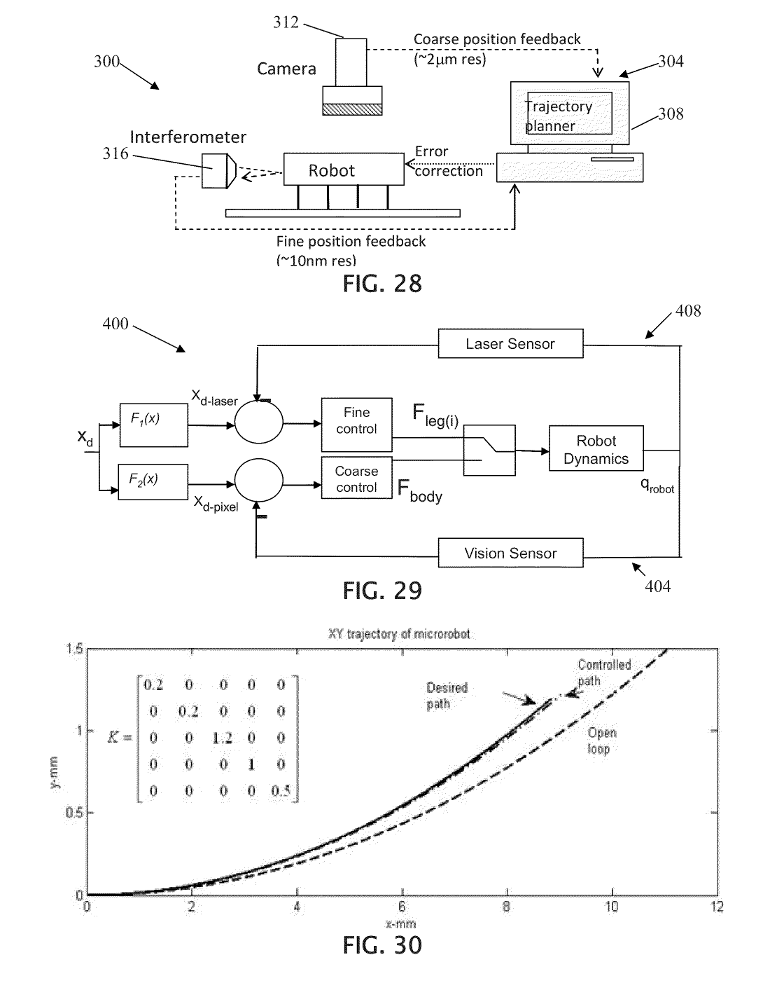

The model in equations (37), (28), and (30) was simulated using MATLAB/Simulink. A custom-designed pulse-generator block allows control of input parameters [A_{left}², A_{right}², F_{left}, F_{right}] and was designed to perform the high-frequency multiplexing of the signals. FIG. 25 shows the input across six legs with pulsing at 1000 Hz and a gait frequency of 45 Hz, while several resulting trajectories are shown in FIG. 26. More particularly, FIG. 25(a) depicts a macroscopic view of the pulses that indicates the actuation of individual legs (e.g., all legs initially actuated, and then sequentially powered down or released). FIG. 25(b) shows a zoomed-in view of FIG. 25(a) that illustrates the individual pulses where current is only actually delivered to a single actuator (and leg) at any given instant. For the present simulation, the microrobot mass was assumed to be 4 g (including mass of the electronics backpack), and the number of legs is six. The deactivating sequence of the legs during the wave gait also influences the trajectory followed. For example, in FIG. 26, the ARRIpede trajectory when all legs are actuated at 45 Hz and 15V shows a slight lateral (left) drift.

FIG. 27 depicts a PWM signal-generation scheme by one of the present microcontrollers. In the present embodiments, this PWM signal can later be used as the base for the gait profile. In the present embodiments, the output-compare module of the dsPIC33FJ32GP202 microcontroller was used to generate the PWM signal. The output-compare module can select either timer#2 or timer#3 for its time base. The module compares the value of the timer with the value of one or two compare registers depending on the operating mode selected. The state of the output pin changes when the timer value matches the compare register value. The output-compare module generates either a single output pulse, or a sequence of output pulses, by changing the state of the output pin on the compare match events. The PWM duty cycle is specified through a secondary output-compare (OC×RS) register, and it acts as a shadow register for the output-compare (OC×R) register.

5.4 Experiments

A system 300 for tracking and/or controlling the microrobot trajectory is shown in FIG. 28. System 300 comprises: a computer 308 having a trajectory planner 304 configured to generate instructions for a robot (e.g., any of the present embodiments of robot 10) to travel along a planned trajectory; and an image sensor 312 coupled to computer 308 and configured to provide image data having a resolution to the computer. In the embodiment shown, computer 308 is configured to generate instructions for the robot to follow the planned trajectory based upon a position of the robot determined from the image data. System 300 comprises a trajectory planner 304 (e.g., computer-executable code or software on a computer-readable medium such as CD, DVD, flash drive, hard drive, RAM, or the like and executable by a computer 308 or other device with processing and/or logic capabilities). Trajectory planner 304 and/or computer 308 can also comprise an image-recognition function, software, and/or computer-executable code (e.g., an IMAQ vision tool). System 300 also comprises a camera 312 (e.g., a camera with large magnification such as 2×, 5×, 10×, 50×, 100×, or more), and/or can comprise a fine-position sensor 316 (e.g., an interferometer). In the embodiment shown, camera 312 and sensor 316 are coupled to computer 308 to such that feedback can be provided in substantially real-time. Camera 312 can be configured to have a resolution on the order of micrometers (e.g., ˜2 μm).

As shown, system 300 also comprises a fine-position sensor 316 coupled to computer 308 and configured to provide fine-position data having a resolution greater than the resolution of the image data; and computer 308 is configured (e.g., by way of trajectory planner 304) to generate instructions for the robot to follow the planned trajectory based upon the position of the robot determined from the image data and from the fine-position data. Fine position sensor 316 can be configured to have a resolution on the order of nanometers (e.g., ˜10 nm). The present experiments, described above with reference to FIGS. 7A-7C and FIG. 10, camera 312 and an IMAQ vision tool were used to track microscale fiducials (e.g., feature 86), as shown in FIGS. 8(a)-8(d). As indicated, computer 312 and/or robot 10 can be configured to enable communication from computer 312 to robot 10 and/or between computer 312 and robot 10 (e.g., to correct or control motion of the robot), such as, for example, by way of wireless communication such as radio-frequency transmission, infrared, WiFi, and/or the like.

### 6. Motion Control

Closed loop control of actuator arrays may be necessary to implement tasks such as compensating for a non-functioning actuator and/or for fine position control. Reference [5] presents information that may be useful in developing vision-based feedback control for thermal actuator arrays. A high-resolution microscope (e.g., coupled to camera 312) can track the motion of an object being manipulated and can used to provide feedback to vary the actuation profile for error compensation. Vision data combined with image processing can be used to determine the exact orientation of a manipulated object. The use of vision for feedback generally limits the motion resolution that can be sensed to the wavelength of light. As a result, interferometry and scanning electron microscopy can also be employed for sensing micro/nano positioning applications, see, e.g., [25,26,27].

The hierarchical control structure for the present robots is shown in FIG. 29. The control system 400 comprises two loops: a coarse control loop 404, and a fine control loop 408, each relaying position feedback over different precision regimes (e.g., μm vs. nm). Control system 400 can be integrated with and/or coupled to system 300, and/or implemented in similar configuration to that of system 300.

6.1 Nonholonomic Path Planner

The ARRIpede equation (37) represents a nonholonomic system. Several teams have implemented nonholonomic path planning for systems with and without drift [31, 32]. The nonholonomic constraint for the ARRIpede can be expressed as:

\dot{x}_{c} sin θ_{c}−\dot{y}_{c} cos θ_{c}=0 (38)

A path planer that maps an initial orientation [X_{ci}Y_{ci}θ_{ci}] to a final orientation [X_{cf}Y_{cf}θ_{cf}] without violating the nonholonomic constraint needed to be developed. To accomplish this, a trajectory planer based on the Pfaffian form was implemented,

dp+r·dq=0 (39)

where ‘p’, ‘q’ and ‘r’ are functions of [X_{cf} Y_{cf}θ_{cf}]. It can be shown that the non nonholonomic constraint described by equation (39) can be transformed to the equivalent form of equation (40) if:

$$[ \begin{matrix}Sin {θ}_{cf} & - Cos {θ}_{cf} & 0 \\ Cos {θ}_{cf} & Sin {θ}_{cf} & 0 \\ 0 & 0 & 1\end{matrix} ] [ \begin{matrix}{X}_{cf} \\ {Y}_{cf} \\ {θ}_{cf}\end{matrix} ] = [ \begin{matrix}q \\ - q \\ r\end{matrix} ] \qquad ( 40 )$$

And equation (40) is easily satisfied by choosing smooth function for [p,q,r] such that:

r=φ₁(t),p=φ₂(r) and q=−φ₂′(r) (41)

Thus, u_{f}(t)=[p q r] is the desired feed-forward input signal that generates a desired trajectory for the microrobot.

6.3 Trajectory Tracker

A Linear Quadratic Regulator (LQR) trajectory tracker can be used to implement closed-loop control. FIG. 30 depicts open- and closed-loop (LQR controller) based trajectories of one of the present robots. The trajectory tracker stabilizes a nonlinear time-varying system about the desired (feedforward) trajectory [33]. The desired trajectory is derived from the path planner described in the previous section, and the tracking controller then helps ensure that the system (robot) will follow the desired trajectory. For ease of notation, the state vector notation q_{body} is replaced with a simple q. The discrete form of the linearized system equation is:

δq(k+1)=A_{d}(k)δq(k)+B_{d}(k)δu(k);δq(0)=0 (42)

where, A_{d} and B_{d} are the discrete versions of the state and input Jacobian variational matrices of equation (37):

$${A}_{d} ( k ) = [ \begin{matrix}0 & 0 & 0 & 0 & 0 \\ 0 & 0 & 0 & 0 & 0 \\ cos θ ( k ) & 0 & 0 & 0 & - v ( k ) sin θ ( k ) \\ sin θ ( k ) & 0 & 0 & 0 & v ( k ) cos θ ( k ) \\ 0 & 1 & 0 & 0 & 0\end{matrix} ] , \\ {B}_{d} = {[ \begin{matrix}1 / {m}_{body} & 0 & 0 & 0 & 0 \\ 0 & 1 / {I}_{zz} & 0 & 0 & 0\end{matrix} ]}^{T} \qquad ( 43 )$$

The control law can be expressed as a feed forward control (which would drive an ideal system along the desired trajectory) and a feedback part that regulates the (non ideal) linearized system to zero. Thus, the control law can be represented in discrete form as:

u(k)=u_{f}(k)+K(k)(q_{d}(k)−\hat{q}(k)) (44)

where u(k)=[τₖ_{_{—}}ₗᵢₙτₖ_{_{—}}_{ang}] is the discretized closed-loop leg force signal, u_{f}(k) is the nominal path-planned input, K(k) is an LQR matrix gain, q_{d}(k) is the desired state of the microrobot generated through simulating the nominal model with the feedforward input u_{f}(k), and \hat{q}(k) is the estimated microrobot state resulting from measurements. To calculate the LQR gain, a state-input cost function can be defined by,

$$J = \frac{1}{2} {\sum }_{k = 0}^{∞} ( {q}^{T} ( k ) Q \cdot q ( k ) + {u}^{T} ( k ) Ru ( k ) ) \qquad ( 45 )$$

A standard Ricatti iteration can be used to calculate the gain matrix K(k):

K(k)=[B_{d}(k)P(k+1)B(k)+R(k)]⁻¹+B_{d}(k)P(k+1)A(k)

P(k)=A_{d}(k)P(k+1)[A(k)−B(k)K(k)]⁻¹+Q(k) (46)

Where, P(k) is the end configuration weighting matrix, Q(k) is the configuration weighting matrix, and R(k) is the control weighting matrix.

6.3.1 Coarse Tracking Controller

The coarse control of the ARRIpede body can be accomplished using a proportional LQR controller that tracks a desired trajectory with gain k_{coarse} combined with a high-magnification optical microscope camera (e.g., camera 312) placed vertically above the robot for feedback. The camera can track one or more fiducials (e.g. feature 86) on top of the robot (e.g., with a resolution of 2 μm at a magnification of 4.5×). For example, when camera 312 used at 1× magnification, the associated field of view (FOV) may be 1 cm×0.8 cm, and thus, the range of motion that can be detected will generally limited to this FOV. The range can be extended by mounting the microscope on an XY gantry, or otherwise configuring the camera to move or be moved with the robot.

6.3.2 Fine Tracking Controller

The low-resolution limitations or constraints of the coarse controller can be enhanced using a fine position sensor 316, for example, a Keyence LK-G10® laser displacement sensor with 10 nm displacement resolution, which can allow or facilitate evaluation of the ARRIpede positioning precision. For the laser displacement sensor described, the range of motion that can be sensed is about 2 mm, with a working distance of about 10 mm. Three displacement sensors can be used to measure incremental motion along X and Y axes. To reflect the 30 μm laser spot, mirrors can be coupled to the robot in vertical configuration relative to body 14 (e.g., downwardly from the ARRIpede belly).

The various illustrative embodiments of the devices, systems, and methods described herein are not intended to be limited to the particular forms disclosed. Rather, they include all modifications, equivalents, and alternatives falling within the scope of the claims. For example, in embodiments, such as the ones depicted above, fine position sensor 316 can comprise a laser displacement sensor, an interferometer, or any other position sensor with suitable resolution. By way of another example, controller 104 can comprise a field-programmable gate array (FPGA) and/or any other suitable equipment or device.

The claims are not intended to include, and should not be interpreted to include, means-plus- or step-plus-function limitations, unless such a limitation is explicitly recited in a given claim using the phrase(s) “means for” or “step for,” respectively.

### REFERENCES

The following references, to the extent that they provide exemplary procedural or other details supplementary to those set forth herein, are specifically incorporated by reference at the locations where they are cited.
1. R. J. Full, “Using Biological Inspiration To Build Artificial Life That Locomotes,” in Proc. of the International Symposium on Evolutionary Robotics from Intelligent Robotics to Artificial Life, Tokyo, Japan, Oct. 18-19, 2001.
2. J. M. Mcmichael, M. S. Francis, “Micro Air Vehicles—Toward A New Dimension In Flight,” DARPA Report, 1997.
3. T. Ebefors et. al, “A Robust Micro Conveyer Realized By Arrayed Polyimide Joint Actuators,” Journal Of Micromechanics And Microengineering, Volume 10, Issue 3, Pp. 337-349, 2000.
4. P. Kladitis, V. Bright, K. Harsh, Y. Lee “Prototype Microrobotics For Micro Positioning In A Manufacturing Process And Micro Unmanned Vehicles,” in Proc. of IEEE 12^{th} Workshop On Micro Electro Mechanical Systems (MEMS), Pp. 570-575, 1999.
5. M. H. Mohebbi, M. L. Terry, K. F. B″ohringer, “Omnidirectional Walking Microrobot Realized By Thermal Microactuator Arrays,” in Proc. of ASME International Mechanical Engineering Congress And Exposition Nov. 11-16, 2001.
6. B. Kim et al., “A Ciliary Based 8-Legged Walking Micro Robot Using Cast IPMC Actuators,” in Proc. of the IEEE International Conference on Robotics & Automation, Taipei, Taiwan, Sep. 14-19, 2003.
7. A. Bonvilain, N. Chaillet, “Microfabricated Thermally Actuated Microrobot,” in Proceedings of the IEEE International Conference on Robotics and Automation, Taipei, Taiwan, Sep. 14-19, 2003.
8. W. Driesen, A. Rida, J. M. Breguet, R. Clavel., ‘Friction based locomotion module for mobile MEMS robots,” in Proc. of IEEE/RSJ International Conference, San Diego, Calif., Pp 3815-3820, 2007.
9. S. Konishi, H. Fujita, “A Conveyance System Using Air Flow Based on the Concept of Distributed Micro Motion Systems,” in Proc. of International Conference on Solid-State Sensors and Actuators, Pacifico, Yokohama, Japan, pp. 28-31, 1993.
10. C. Liu, T. Tsai, Y. C. Liu, P., Will, C. M. Ho, “A Micromachined Permalloy Magnetic Actuator Array for Micro Robotics Assembly Systems,” in Proc. of International. Conference on Solid-State Sensors and Actuators, Stockholm, Sweden, vol. 1, pp. 328-331, 1995.
11. T. Furihata, T. Hirano, H. Fujita, “Array-driven ultrasonic microactuators,” in Proc. of the 9th International. Conference on Solid-State Sensors and Actuators, vol. 1, pp. 1056-1059, 1991.
12. K. F. Böhringer, B. R. Donald, N. C. MacDonald, “Single-Crystal Silicon Actuator Arrays for Micro Manipulation Tasks,” in Proc. of IEEE Workshop on Micro Electro Mechanical Systems (MEMS), San Diego, Calif., pp. 7-12, 1996.
13. N. Takeshima, H. Fujita, “Polyimide Bimorph Actuators for a Ciliary Motion System,” in Proc. of ASME WAM Symposium on Micromechanical Sensors, Actuators, and Systems, vol. DSC-32, pp. 203-209, 1991.
14. T. Ebefors, J. Mattsson, E. K\ddot{}alvesten, G. Stemme, “A robust micro conveyor realized by arrayed polyimide joint actuators,” in Proc. of IEEE 12th Workshop on Micro Electro Mechanical Systems (MEMS), pp. 576-581, 1999.
15. B. R. Donald et al., “An Untethered, Electrostatic, Globally-Controllable MEMS Micro-Robot,” Journal of Microelectromechanical Systems, Vol 15, No. 1, February 2006.
16. A. N. Das, P. Zhang, W. H. Lee, D. O. Popa, H. E. Stephanou, “μ³: Multiscale, Deterministic Micro-Nano Assembly System for Construction of On-Wafer Microrobots,” in Proc. of IEEE International Conference on Robotics & Automation, Rome, Italy, Pp. 461-466, 2007.
17. K. Tsui, A. A. Geisberger, M. Ellis, G. D. Skidmore, “Micromachined end-effector and techniques for directed MEMS assembly,” Journal of Micromechanics and Microengineering. Vol. 14, Pp. 542-549, 2004.
18. D. O. Popa, B. H. Kang, J. T. Wen, H. E. Stephanou, G. Skidmore and A. Geisberger, “Dynamic Modeling and Open-Loop Control Of Thermal Bimorph MEMS Actuators”, in Proc. of IEEE International Conference on Robotics & Automation, Taipei, Taiwan, September 2003.
19. D. O. Popa, H. E. Stephanou, “Micro and Meso Scale Robotic Assembly”, in SME Journal of Manufacturing Processes, Vol. 6, No. 1, Pp52-71, 2004.
20. R. Murthy, Dan. O. Popa, “Articulated four axis microrobot with large work volume,” to appear In proceedings if IEEE International Conference on Robotics & Automation, Japan, May 2009.
21. R. Murthy, Dan. O. Popa, “Nonholonomic Control of an Assembled Microcrawler,” Proceedings if International Federation of Automatic Control, Japan, May 2009.
22. R. Murthy, Dan. O. Popa, “Articulated MEMS Robot for Microfactory Applications,” Proceedings of ASME IDETC Micro & Nano Systems Conference, San Diego, August 2009.
23. K. Rabenorosoa, A. N. Das, R. Murthy, D. O. Popa, C. Clevy., “Precise Motion Control of a Piezoelectric Microgripper for Microspectrometer Assembly, Proceedings if ASME IDETC Micro & Nano Systems Conference, San Diego, August 2009.
24. J. E. Luntz, W. Messner, H. Choset, “Distributed Manipulation Using Discrete Actuator Arrays,” The International Journal of Robotics Research 2001; Vol 20; 553.
25. H. Wörn et al., “From decimeter- to centimeter-sized mobile microrobots—the development of the MINIMAN system,” Proc. SPIE, Vol. 4568, 2001.
26. S. Fatikow, F. Schmoeckel, “Smart flexible microrobots for SEM applications”; Journal of intelligent Material Systems and Structures Vol 11 No. 3, pp. 191-198, 2000.
27. F. Schmoeckel; H. Wörn; M. Kiefer, “The Scanning Electron Microscope as Sensor System for Mobile Microrobots,” 8th IEEE Int. Conf. on Emerging Technologies and Factory Automation, ETFA 2001, Oct. 15-18, 2001.
28. R. Murthy, A. N. Das, D. O. Popa, “ARRIpede: A Stick-Slip Micro Crawler/Conveyor Robot Constructed via 2½D MEMS Assembly,” In Proceedings of the IEEE International Conference on Intelligent Robots and Systems, Nice, France, September 2008.
29. G. Pappas, K. J. Kyriakopoulos, “Modeling and Feedback Control of Nonholonomic Mobile Vehicles,” in Proceedings of the 31st conference on decision and control, Tuscon, Ariz. 1992.
30. A. Gholipour, M. J. Yazdanpanah, “Dynamic tracking control of nonholonomic mobile robot with model reference adaptation for uncertain parameters,” in Proceedings of ECC 2003: European Control Conference, Cambridge, UK, September 2003.
31. J. M. Godhavn, A. Balluchi, L. Crawford, S. Sastry, “Path planning for nonholonomic systems with drift,” In Proceedings of the American Control Conference, 1997.
32. E. Papadopoulos, V. Poulakakis, I. Papadimitriou, “On Path Planning and Obstacle Avoidance for Nonholonomic Platforms with Manipulators,”. International Journal of Robotics Research, Volume 21(4): Pp:367-386 2002.
33. D. O. Popa, J. T. Wen, “Characterization of Singular Controls for nonholonomic motion planning”, in Proceedings of IFAC World Congress, San Francisco, June 1996.

1. A robot comprising:
a body;
a plurality of actuators coupled to the body, the plurality of actuators each actuatable in a single degree-of-freedom (DOF);
a plurality of legs each coupled in fixed relation to at least a portion of a different actuator and extending from that actuator at a nonparallel angle relative to the DOF of that actuator;
where the robot is configured such that if the robot is disposed with the legs extending upward from the body and a payload is supported by the legs above the body, the actuators can move the legs in a sequence to move the payload laterally.

2. The robot of claim 1, where the robot is configured such that if the robot is disposed on a suitable surface with the legs supporting the body above the surface, the actuators can move the legs in a sequence to move the robot across the surface.

3. The robot of claim 1, where each leg is substantially perpendicular to the DOF of the actuator to which the leg is coupled.

4. The robot of claim 3, where the DOF of each actuator is linear along an axis, and where the axis of at least one actuator is substantially parallel to the axis of at least one other actuator.

5. The robot of claim 4, where the axes of all the actuators are substantially parallel to each other.

6. The robot of claim 1, where the body comprises a microelectromechanical-systems (MEMS) die having a plurality of prismatic joints, each joint including one of the actuators and a socket coupled to that actuator and configured to be coupled to a leg, and where the DOF of each actuator is in substantially the same plane as the DOF of each of the other actuators.

7. The robot of claim 6, where each leg is substantially perpendicular to the DOF of the actuator to which the leg is coupled.

8. The robot of claim 7, where the legs comprise Silicon.

9. (canceled)

10. The robot of claim 7, where each actuator is a chevron electro-thermal actuator and each leg is coupled to a socket with a snap fastener.

11. (canceled)

12. The robot of claim 10, further comprising:
a plurality of boots each coupled to a different one of the legs.

13. The robot of claim 6, further comprising:
an electronics module coupled to the actuators and configured to actuate the actuators to sequentially move the legs relative to the body.

14. The robot of claim 13, where the electronics module is configured such that if the actuators are actuated to sequentially move the legs at a rate, current is time-multiplexed to the actuators at a faster rate than the rate of the sequential movement of the legs.

15. The robot of claim 14, where the electronics module comprises a power module and a controller.

16. The robot of claim 1, further comprising:
a microcontroller coupled to the plurality of actuators and configured such that if coupled to a power source, the microcontroller can be activated to sequentially actuate the actuators at a rate by time-multiplexing current to the actuators at a faster rate than the rate of sequential actuation of the actuators.

17. The robot of claim 16, where the microcontroller is configured such that if the rate of sequential actuation of the actuators is reduced by a factor of ten, the rate of power consumption of the actuators is reduced by a factor of about one hundred.

18. The robot of claim 16, where the microcontroller is configured such that if the microcontroller is activated to sequentially actuate the actuators, the microcontroller can sequentially actuate the actuators to consume 100 to 400 milliamps (mA) of current at a voltage of eighteen to twenty volts across the actuators.

19. The robot of claim 13, where the electronics module comprises:
a microcontroller coupled to the actuators and configured such that if coupled to a power source, the microcontroller can be activated to sequentially actuate the actuators at a rate by time-multiplexing current to the actuators at a faster rate than the rate of sequential actuation of the actuators.

20. The robot of claim 19, where the microcontroller is configured such that if the rate of sequential actuation of the actuators is reduced by a factor of ten, the rate of power consumption of the actuators is reduced by a factor of about one hundred.

21. The robot of claim 20, where the microcontroller is configured such that if the microcontroller is activated to sequentially actuate the actuators, the microcontroller can sequentially actuate the actuators to consume 100 to 400 milliamps (mA) of current at a voltage of eighteen to twenty volts across the actuators.

22. The robot of claim 19, where the microcontroller is configured to sequentially actuate one or more actuators at a first frequency and one or more other actuators at a second frequency to steer the microrobot according to a fifth-order vector model.

23. A system comprising:
a computer having a trajectory planner configured to generate instructions for a robot to travel along a planned trajectory, the robot comprising:
a body;
a plurality of actuators coupled to the body, the plurality of actuators each actuatable in a single degree-of-freedom (DOF); and
a plurality of legs each coupled to a different actuator and extending from that actuator at a nonparallel angle relative to the DOF of that actuator;
where the robot is configured such that if the robot is disposed with the legs extending upward from the body and a payload is supported by the legs above the body, the actuators can move the legs in a sequence to move the payload laterally; and
an image sensor coupled to the computer and configured to provide image data having a resolution to the computer;
where the computer is configured to generate instructions for the robot to follow the planned trajectory based upon a position of the robot determined from the image data.

24. The system of claim 23, further comprising:
a fine-position sensor coupled to the computer and configured to provide fine-position data having a resolution greater than the resolution of the image data;
where the computer is configured to generate instructions for the robot to follow the planned trajectory based upon the position of the robot determined from the image data and from the fine-position data.
